(19) United States
(12) Patent Application Publication
(10) Pub. No.: US 2024/0230563 A1
(43) Pub. Date: Jul. 11, 2024

(54) Determination of Effective Ground Thermal Properties for Heat Exchange System

(71) Applicant: Ronald B. Foster, Carrollton, TX (US)

(72) Inventor: Ronald B. Foster, Carrollton, TX (US)

(21) Appl. No.: 18/402,556

(22) Filed: Jan. 2, 2024

Related U.S. Application Data
(60) Provisional application No. 63/436,652, filed on Jan. 2, 2023.
(60) Provisional application No. 63/438,621, filed on Jan. 12, 2023.

(51) Int. Cl. G01N 25/18; F28F 21/08; F28F 27/02; G01N 25/00

(52) U.S. Cl. CPC G01N 25/18; F28F 21/085; F28F 27/02; G01N 25/005; F28F 2200/005; F28F 2250/104

(57) ABSTRACT

The present invention is a system and method for determining effective ground thermal properties. Accurate prediction of required loop length for geothermal heat exchange systems is critical for optimizing performance and associated cost, yet limited by lack of knowledge of the effective average thermal properties of the surrounding ground. Testing involves first charging the ground loop by circulating fluid at constant temperature and constant rate of heat input, then halting heat input and monitoring the ground loop temperatures during discharge. One aspect of the invention is to enable separate determination of effective ground thermal conductivity and volumetric heat capacity first by adopting design elements resulting in improved reproducibility, and second by evaluating thermal conductivity near the time when the quotient Q of later discharge temperature to start-of-discharge fluid temperature is almost independent of volumetric heat capacity. Evaluation discharge times are specific to both ground loop design and charging conditions.

### BACKGROUND OF THE INVENTION

A conventional air-based air conditioning system enables cooling of a building interior. The four main components of an AC system are the compressor, condensor, thermal expansion valve, and evaporator. Condensor and evaporator are examples of a heat exchanger, which simply takes advantage of the fact that heat flows from a warmer body to a cooler body. A fan blowing across the outdoor condensor accelerates rejection of heat from a circulating fluid at a higher temperature that the surrounding air. At the same time, the evaporator is indoors and a fan blowing across the evaporator accelerates absorption of heat into the circulating fluid. The fan also assists in distributing the now cooler air throughout the building.

An air-based heat pump is a simple modification of a conventional air conditioning system to make it useful for heating a building during cold weather. The compressor always takes in gas that is cooler and lower pressure and outputs gas that is hotter and higher pressure. By adding a Reversing Valve, hot, high pressure fluid that goes outside to the condensor in summer instead goes inside in winter. The input side is also reversed. Since both evaporators and condensors are just radiators with fans, no real change is required with these components. In effect, the function of condensor and evaporator is re-defined when a heat pump is reversed. The other significant change with a heat pump is the addition of a second expansion valve outdoors. This valve creates cold air going to the outside heat exchanger, such that it can pick up heat from the ambient. Since there are now two expansion valves, two check valves are added to ensure that only one of the expansion valves is operating at any given time. These are the only modifications required to enhance a conventional air conditioning system for pumping heat from outdoors into the building during the winter heating months, as well as cooling the building during summer months.

Whereas an air-based heat pump exchanges heat with the ambient air, geothermal ground-source heat pump (GSHP) relies on a “ground loop” to exchange heat between a fluid circulating in one or more pipes and the surrounding ground.

For GSHP systems, refrigerant is not usually sent directly into the ground loop. Rather, the refrigerant, whether gas or liquid, is routed through a heat exchanger to heat or cool a liquid that is in turn circulated through a ground loop. Simply put, a ground loop serves the purpose of heating or cooling as needed to bring the “entering water temperature” (EWT) within the operating range of the heat pump. The “leaving water temperature” (LWT) differs from EWT to the extent that heat is exchanged as the fluid circulates through the loop.

In winter, a ground loop having circulating fluid such as a water-antifreeze mixture absorbs heat from the ground and transfers it to the heat pump fluid (refrigerant) via a liquid-to-liquid heat exchanger. The interior condensor then transfers heat to the building interior. In effect, the ground loop acts as the evaporator. In summer, the function is reversed with the ground loop fulfilling the role of condensor while heat is rejected from circulating fluid in a pipe to the surrounding ground.

Equations governing such heat exchange are useful for estimating two key aspects of a ground loop:
1) The rate per unit area at which heat can be exchanged between fluid circulated in the pipes and the ground surrounding the pipes.
2) The amount of surface area required to be in contact with the ground in order to exchange a targeted amount of heat.

While ground loops can be placed horizontally, a vertical loop does a much better job of tapping into the “constant temperature zone” found 10-20 feet below the ground surface. The depth at which the temperature is approximately constant year-round depends on the ground materials properties and the latitude. Essentially, heat from the Sun is absorbed at the surface during summer and diffuses downward. In winter, the ground still absorbs some energy from the Sun, but also loses heat to the cooler air. Roughly, at three diffusion lengths or more, such annual variations due to sunlight and air temperature variations have no effect. For example, with a diffusion length of 5 feet, ground temperature hardly varies throughout the year at a depth beginning at 15 feet and extending to several hundred feet.

Vertical GSHP loops today are typically formed by first drilling a borehole to 150-200 foot depth using apparatuses and methods typical of water well drilling. Next, one or more U-tube loops are placed into the borehole, followed by filling the remaining volume with thermally-conductive grout. Roughly, a U-tube loop installed in a 200 foot deep borehole can exchange energy equivalent to one ton (12,000 BTU) of heating/cooling. The average residential requirement of 3-5 tons can generally be met with 600-1,000 feet of borehole, perhaps divided into 3-5 separate boreholes. These are rough estimates and depend strongly on the ground properties.

Multiple U-tube loops are connected in serial/parallel combination before routing to the heat pump heat exchanger. One key advantage of connecting multiple pipe sections, one or more for each hole, is to minimize pressure drop along the pipes. Less pressure drop means that thinner pipe walls can be used, and also that lower pump horsepower is needed.

Parallel connections potentially create an issue with pressure balancing the multiple U-tube loops. One solution is to connect the pipe sections to an adjustable manifold including valves for evacuation and testing as well as for active balancing of flow rates and pressures. In addition, temperature sensors are installed near the manifolds to monitor at least EWT and LWT for each ground loop.

Boreholes certainly must be large enough to accommodate one down-going pipe and one up-coming pipe, with some spacing between the two pipes. Most typically, the borehole is about 6″ (150 mm) diameter. This is in part to allow adequate spacing for the two pipes, but in practice the hole must be large enough to accommodate the conventional drill string with bit.

Once a borehole is formed and the drill string is removed, the next step is to place U-tube loops into the hole. Besides cost, U-tube pipe materials may be compared for thermal conductivity; lateral stress resistance; stress cracking resistance; corrosion resistance; chemical compatibility; thermal expansion and contraction; and pressure resistance for pipes with associated grout. Because of the relatively thin pipe walls and overall geometries, pipe thermal resistance is not usually the largest contributing factor to overall resistance of the loop to the surrounding ground. Therefore, U-tube pipe materials having low cost but relatively low thermal conductivity are often employed.

Today, U-tubes are often formed of low-cost plastic pipe, and especially HDPE or PEXa pipe, which have been proven to meet lifetime requirements. HDPE PE4710 pipe is quite common, with standard pipe sizes of ¾″, 1″ and ¼″. Typically, larger diameter pipe is associated with deeper, larger diameter boreholes.

A U-bend or U-turn element is fitted to turn around flow from the down-going pipe to the up-coming pipe. Custom, highly-engineered U-bends may be fusion bonded to plastic pipe ends. Optionally, a completed U-tube loop is factory tested at pressure to ensure no leaks. The HDPE U-tube assembly is then wound onto a reel for distribution. PEXa is an alternate material that has been successfully applied, and is compatible with both fusion bonding and ordinary compression fittings.

Due to the details of U-bend design, the two U-tube pipes are necessarily somewhat spaced apart. For example, the lateral width taken up by a ¾ inch diameter loop might be 2.375″ center-to-center; compared to 3.25″ for 1″ diameter and 3.75″ for 1.25 inch diameter.

For efficient heat exchange to the surrounding ground, it is critical that the U-tube loops be in good thermal contact with the ground. Any air gaps are deadly to the thermal path, and may lead to significant and perhaps permanent reduction in the heat exchange capacity of the installation. Therefore, once the pipe sections are placed into the boreholes, grout is added to fill the space between the pipes and the outer edges of the borehole.

Common practice is to attach a “tremie pipe” while feeding U-tubes into a borehole, such that the tremie pipe is simultaneously fed into the hole. The tremie pipe, typically about 1″ to 1½″ diameter, is used for adding grout. After grout is mixed to a relatively low viscosity, it is pumped at pressure through the tremie pipe and into the hole. The pressure is sufficient to ensure that the grout flows well around any air or water pockets or other obstructions such as cave-ins from the surrounding borehole walls. Air or water is then pushed upwards. The tremie pipe is slowly withdrawn as the grout is dispensed, until the grout can be seen filling at the top of the borehole.

Grout serves multiple purposes of sealing the hole and minimizing thermal contact resistance between the pipe and the surrounding soil. Grout flows to permanently fill any variations in diameter of the borehole, effectively creating a custom fit. With most soil types, grout can be mostly sand and hydrated Bentonite, which is a relatively inexpensive type of clay that tends to swell a bit and “seal” the hole against water infiltration. However, a mixture of Portland cement and sand, with perhaps some additive amounts of Bentonite and a superplasticizer, is sometimes used. Cement-based grout is more expensive. In addition, cement-based grout is more rigid and may be susceptible to formation of gaps with the ground as expansion and contraction occurs over time. Generally, Bentonite-based grouts form a flexible connection, and also allow for some ongoing exchange of moisture between the grout and the surrounding ground.

There has been much emphasis on increasing the thermal conductivity of grout over the recent few decades. While historically grout thermal conductivity κ_{GROUT} was limited to about 0.8 W/m-° K, today grout is available with thermal conductivity up to about 2.7 W/m-° K. Increased thermal conductivity has been achieved by filling the clay base with high thermal-conductivity materials such as graphite flakes or soot.

Due to convective resistance between flowing fluid and pipe sidewalls, heat exchange efficiency also depends on the speed of the circulating fluid. With GSHP, fluid speed and other parameters are typically adjusted to maintain the difference (EWT−LWT) in the range of 5-15° F. (3-8° C.).

To complete installation of the GSHP ground loop heat exchanger, connections are made to the protruding pipes, which are connected to a manifold in series/parallel configurations.

Standard analysis practice is to consider R_{GND}, the thermal resistance of the ground, separately from the borehole thermal resistance (BTR). BTR is the sum of the components of resistance that are interior to the borehole wall, including a) convective resistance between the circulating fluid and the inner diameter of the tubes; b) conductive resistance of the tube walls; c) conductive resistance of grout between the outer diameter of the tubes and the borehole wall; and d) potentially a contact resistance between the outer portion of the grout and the surrounding ground. Partitioning of BTR might seem somewhat arbitrary, since energy is beneficially exchanged with the pipe and grout as well as the surrounding soil. The key distinction is that each of the components of BTR can be directly influenced by design choices. Alternatively, with conventional design ground resistance cannot be directly influenced. Also, ground resistance as viewed from the borehole edge is not constant, but rather varies over time as heat energy is charged and discharged. For accurate analysis, the thermal history of the surrounding ground must be taken into account in determining ground resistance.

Optimal, effective design of a GSHP exchange loop strongly depends on knowledge of the ground thermal properties. Due to the high costs of forming the borehole and populating with a grouted U-tube loop, it is imperative that L, the total U-tube length, be minimized. However, the ground properties are seldom known to high precision. Many approaches have been developed to better estimate the ground thermal properties. Regardless, the cost of obtaining more accurate data remains very high. To the extent that ground properties are unknown, the installation must be over-engineered with unnecessarily increased length. There is a need for a more accurate system and method of determining ground thermal properties, leading to determination of optimal U-tube length L.

The most common approach to gaining information on ground properties is to commission a thermal response test (TRT) study prior to committing to a potential GSHP project. Project approval may be conditioned on receipt of acceptable reports on ground thermal properties. However, the cost of an independent study can range to several thousand dollars. This is beyond the reach of many proposed projects, especially smaller projects such as residential or small commercial installations. As a consequence, projects are often designed and completed based on estimates of ground thermal properties previously obtained on larger commercial projects in the nearby area. Due to limited confidence in these numbers, designers necessarily over-engineer the project to ensure adequate minimum performance. This in turn leads to cost increases in the range of 10-50% compared to an optimal design. There is an urgent need for a less costly method of obtaining effective ground thermal properties, thereby enabling optimal design.

Another issue with testing for ground thermal properties is that there may be significant variation in the properties as a function of depth. It is well known that the Earth's surface is layered, with each layer potentially having different thermal properties. The ground properties at 20 foot depth may be quite different from the ground properties at 200 foot depth. In addition, fissures in rock or pockets of either stagnant or flowing water can significantly impact the average or effective ground thermal properties. Even when many coring samples are collected and tested for thermal properties, obviously soil samples cannot be collected from water pockets. Sampling over the entire heat exchanger installation depth is highly desirable. Unfortunately, deeper sampling incurs additional expense. For these several reasons, test-in-place measurement must always be favored as giving a more representative estimate of effective ground thermal properties. There is an ongoing need for cost-effective, test-in-place systems, apparatuses and methods capable of producing accurate estimates of the effective ground thermal properties. This is especially the case when water pockets are encountered.

Average or effective ground thermal conductivity and volumetric heat capacity depend on the actual distribution of soil types as well as both soil porosity and moisture content. Overall, testing to obtain truly representative effective ground properties is a challenging task, and there is a need to better represent actual ground properties.

Prior art has focused on installing a representative U-tube; and then circulating fluid to thermally charge the U-tube and ground for a significant time period while simultaneously measuring the temperature of the circulating fluid over time. The results are then fitted to a mathematical model in order to find the most likely ground thermal properties. For one example, a transient, 2D numerical finite volume model of the vertical borehole might be applied, with parameters fitted to minimize the differences between measured and modeled temperature versus time. Using such methods, critical assumptions must be made on both nominal BTR value and variation in BTR due to pipe spacing and other installation variables. For example, with conventional ground loops it is well known that spacing of down-going and up-coming pipes is a significant installation variable, and further that it is difficult to ensure uniform spacing over the entire U-tube length. The accuracy of such methods is significantly enhanced by both fundamentally reducing nominal BTR values and by improving uniformity and reproducibility of pipe spacing and other variables.

There is significant performance benefit in reducing nominal BTR, since this leads to more energy being exchanged into the ground in a given time period. Further, it is likely that specific changes resulting in reduced nominal BTR will also result in reduced variation in BTR. To the extent that BTR is precisely known, a matrix of simulations might be made based on assumed ground thermal properties and measured fluid temperatures. Using such simulations, there is opportunity to estimate the ground thermal properties by best fit to the evolution of fluid temperature over time.

Primarily, BTR can be minimized by investing in grout having higher thermal conductivity, and by maximizing spacing between the pipes composing the U-tubes. One partially successful approach used with conventional GSHP U-tubes is to place spring clips between the two pipes to separate them during insertion into the borehole and maintain the separation until grouting is completed.

If practical, BTR might also be reduced by increasing the thermal conductivity of materials from which U-tubes are constructed. There is some direct tradeoff between costs of forming the borehole and costs of the U-tube and other materials. If the U-tube is constructed from materials having higher thermal conductivity, heat exchange efficiency is increased and less borehole depth is required to meet exchange requirements. For example, copper pipe has more than 200× greater thermal conductivity compared to HDPE. However, cost of copper pipe is several multiples of the cost of HDPE pipe. Depending on details, total costs might be increased as higher thermal conductivity pipe is employed.

Overall, basic information on ground properties is crucial to designing a cost-effective GSHP ground loop. In advance of fully committing to any installation, knowledge must be gained on average ground parameters:
1) Undisturbed ground temperature
2) Ground thermal conductivity κ_{GND}
3) Ground volumetric heat capacity (product of density ρ and specific heat capacity C_{P})

Although thermal diffusivity α is initially unknown, it can be calculated once the other properties are known.

Current methods of testing to determine ground thermal conductivity and volumetric heat capacity are expensive. In addition, using prior art approaches it is difficult to determine the average or effective ground properties over the full length of the heat exchanger.

With regards to undisturbed ground temperature, maps are readily available to predict the temperature with reasonable accuracy. Temperature map contour lines tend to follow location latitude. Ground temperature data, primarily obtained from measurement of well water temperatures, has been codified in the ASHRAE Handbook. Included are annual average, amplitude, and phase angle (number of days relative to January when the minimum ground temperature occurs). This enables simulations based on a simple harmonic model. Due to other unknowns, it is vitally important to treat the undisturbed ground temperature as being known.

Of course, both thermal conductivity κ_{GND} and volumetric heat capacity ρC_{P_GND} are initially unknown and must be estimated. Although ground thermal conductivity broadly varies from 0.25-8 W/m·° K, in practice values are limited to 0.8-3.2 W/m·° K. For values below 0.8, GSHP is typically judged to not be economically practical. On the other hand, values above about 3.2 are generally associated with solid rock and again this is often not economically practical. Similarly, volumetric heat capacity ρC_{P_GND} broadly ranges from 1×10⁶ to 5×10⁶ J/m³-° K, but typically ranges from about 2.1×10⁶ to 4.4×10⁶ J/kg-° K. Values for both thermal conductivity and volumetric heat capacity must be accurately estimated.

The conventional approach to analyzing vertical, cylindrical heat exchangers is based on the infinite line-source model. Valid a few hours after initiating testing, estimates based on the infinite line-source model conveniently rely on a logarithmic dependence of temperature vs time.

The output of the infinite line source model, valid when αt/r²>5, is a good starting point for analysis of testing approaches. The value of ground resistance as a function of time and radius from the borehole is generally written as:

$$\\ \begin{matrix}R ( r , τ ) ) = \frac{1}{4 π {κ}_{GND}} {E}_{1} ( \frac{{r}^{{}_{} 2}}{4 α τ} ) ≅ \frac{1}{4 π {κ}_{GND}} \{ ln ( \frac{4 α τ}{{r}^{{}_{} 2}} ) - γ \} & Equation 1\end{matrix}$$

where γ=0.5772 is the Euler-Mascheroni constant

While this provides a general equation for ground resistance with variable radius, when separating the problem into R_{GND} and BTR, the ground resistance from radius r_{BORE} to infinity is of most interest. With this in mind, it is useful to rearrange the above equation. Using math rules for manipulating logarithm, the approximation can be rewritten as:

$$\\ \begin{matrix}R ( r , τ ) ≅ \frac{1}{2 π {κ}_{GND}} \{ ln ( \frac{1.5 \sqrt{α t}}{{r}_{BORE}} \} = \frac{1}{2 π {κ}_{GND}} \{ ln ( \frac{1.5 \sqrt{{κ}_{GND} t / ρ {C}_{P \_ GND}}}{{r}_{BORE}} \} & Equation 2\end{matrix}$$

where R(r, τ) is the ground resistance as a function of radius from the borehole center and time
   α is the thermal diffusivity
   r_{BORE} is the radius measured from the center of the borehole
   κ_{GND} is the thermal conductivity
   ρ_{GND} is the average density of the ground
   C_{P_GND} is the average specific heat capacity of the ground

In this form, it can be observed that the equation is simply based on the log mean of the two radii r_{BORE} and 1.5\sqrt{αt}. This equation forms the basis for calculations of R_{GND} over time, and explicitly shows the dependence of resistance on κ_{GND} and ρC_{P_GND}, as well as time.

The infinite line-source model is successful in many circumstances, but less successful when heat input is varied from ON to OFF. The model relies on the Principle of Superposition to predict heat exchange with less than 100% duty cycle. Applying the superposition method, one first assumes steady-state ON operation into the foreseeable future, then after a set delay subtracts the reverse, or OFF operation into the foreseeable future. The result is a single pulse of ON operation. This would be correct except for the critical fact that diffusion never stops. Switching from supply ON to supply OFF does not stop further spread of heat already coupled into the surrounding ground. Due to this limitation, the infinite line-source model is inadequate for modeling a discharge phase when heat input power is zeroed. Partially for this reason, current practice for thermal response testing (TRT) is normally based on thermal charging with constant heat input power, as opposed to discharging. A flexible analysis methodology that better approximates actual system performance with variation in duty cycle is demanded.

Furthermore, curve-fitting of the initial response to thermal charging of the ground loop is not guaranteed to produce a unique solution with both thermal conductivity κ_{GND} and volumetric heat capacity ρC_{P_GND} correctly identified. With too many parameters available, multiple solutions nicely fitting the curve may be found. There is a need for a system and method of solving for both thermal conductivity κ_{GND} and volumetric heat capacity ρC_{P_GND} within relatively narrow bounds.

There is also a need for a system and method of determining ground thermal properties that carry minimal risk of contaminating underground water sources.

### REFERENCES

Bennet, J., Claesson, J., Hellstrom, G., “Multipole Method to Compute the Conductive Heat Transfer to and between Pipes in a Composite Cylinder”, Department of Building Physics, Lund Institute of Technology, Lund, Sweden, 1987
P. R. Strickland, “The Thermal Equivalent Circuit of a Transistor”, IBM Journal, January 1959
Y. C. Gerstenmaier, W. Kiffe, and G. Wachutka, “Combination of Thermal Subsystems Modeled by Rapid Circuit Transformation”, Therminic, 2007
U.S. Patent Applications 2013/0112368, “Geothermal Well Loop”, Albert A. Koenig
U.S. Pat. No. 8,005,640, “Thermal response geothermal testing unit”, Chiefetz
U.S. Pat. No. 10,047,975, “System and method for thermal response testing”, Kwemo ASHRAE Handbook 2011, HVAC Applications
Abu-Hamdeh, H., “Thermal Properties of Soils as affected by Density and Water Content”, Biosystems Engineering (2003) 86 (1), 97-102

### SUMMARY OF THE INVENTION

The present invention is based on a system, methods, and apparatuses for determining effective ground thermal properties. Design elements that result in more consistently reproducible values of borehole thermal resistance (BTR) are optionally employed.

Applying an electrical analogy, the borehole, U-tube and any other pipes as well as the surrounding ground are modeled as an RC network. With such model and voltage inputs representing temperature, simple, SPICE analysis is rapidly executed to simulate charge and discharge of the RC network over time. Both effective ground thermal conductivity and volumetric heat capacity are varied to complete a matrix of simulations. The results of the simulation matrix are then optionally summarized in quadratic equation form with thermal conductivity as a variable, allowing for direct solution for thermal conductivity given a specific value of volumetric heat capacity. Using in succession high and low values of volumetric heat capacity, the possible range of effective thermal conductivity is found.

For any specific design comprised of borehole or optionally shell pipe; U-tube; and grout or other filler, effective thermal conductivity is optionally found by referring to a lookup table containing pre-simulated and calculated values.

Once thermal conductivity is determined, volumetric heat capacity ρC_{P_GND} is determined to within a relatively narrow range by evaluating quotient Q(t) at other times where the ratio is substantially dependent on ρC_{P_GND}. (Terms quotient and ratio are herein used interchangeably.)

In some embodiments, the invention allows for improved reproducibility of BTR by installation of a shell pipe having reduced radius compared to a conventional borehole and thermal conductivity greater than 5 W/m-° K. With a precisely reproducible shell pipe inner diameter, grout fills a smaller, consistently repeatable cross-sectional area, and therefore has less contribution to variation in BTR. Forming the U-tube from materials having high thermal conductivity leads to further minimization of BTR. Minimization of BTR is not required by the present invention, but in several embodiments contributes to a more narrow range of estimated values for effective thermal conductivity. On the other hand, precisely reproducible BTR is a critical enabler for highly accurate determination of ground properties.

In all embodiments, it is understood that both an elongate shell pipe and U-tubes may optionally be constructed of many joined segments each having length of several meters, with additional segments joined when the current shell pipe or U-tube has almost penetrated the ground. Alternatively, in some embodiments U-tubes may be formed of plastic pipe wrapped around a spindle and having sufficient length to complete the entire installation without need for joining to another segment.

In a first preferred embodiment, discharge of thermal energy immediately following charging is measured and recorded, with variation of temperature versus time matched to simulation outputs. Ideally, determination of thermal conductivity is made by comparing the ratio of temperature at a later time to the temperature at the time when charging is completed and the heating cycle is halted. This ratio is herein defined as quotient Q(t). By careful choice of charge and discharge times and temperatures, thermal conductivity κ_{GND} is determined to within a narrow range by reference to design-specific simulations. In particular, following charge a discharge time is chosen for a “zero crossing”, where quotient Q(t) is almost independent of volumetric heat capacity ρC_{P}. Such choice effectively allows for separation of variables.

In a second embodiment, a method for installing a ground-based heat exchange system and testing to determine effective ground properties includes the steps of a) directly pushing a shell pipe portion of a first element of a ground loop system into the ground; b) connecting first element of said shell pipe portion to second element of shell pipe portion and further directly pushing into the ground; c) repeating connection and direct push for subsequent elements until desired total insertion length has been reached; d) positioning a U-tube assembly, comprising a down pipe, an up pipe, and a U-turn element to conduct fluid from down pipe to up pipe with minimal flow restriction, into said shell pipe; e) filling remaining shell pipe interior volume with conductive material to thermally connect the outer diameters of down and up pipes to the internal diameter of said shell pipe; f) forcing circulation of heated fluid through down pipe by connecting to outlet of a pump and a flow-through heating apparatus having calibrated thermal energy transfer rate; g) activating flow-through heating apparatus and operating for a defined charging time; i) de-activating flow-through heating apparatus to initiate discharge; g) measuring and recording entering water temperature EWT and leaving water temperature LWT at several different discharge times; j) modeling the U-tubes, filler, shell pipe and surrounding ground as a resistor-capacitor network; k) simulating discharge temperature at multiple specific times and for each time a range of values of thermal conductivity and volumetric heat capacity; l) summarizing data for each discharge time in quadratic equation form with thermal conductivity as a variable; m) solving for effective ground thermal conductivity at a time when discharge temperature is nearly independent of volumetric heat capacity; n) inserting solution on thermal conductivity as an input and solving for effective ground volumetric heat capacity at a time when discharge temperature is significantly dependent on volumetric heat capacity.

In a third embodiment, a heat exchange system for testing to determine effective ground thermal properties is disclosed, wherein a pilot hole having diameter less than the diameter of follow-on shell pipe is formed in the ground. A conically-shaped head is attached to the bottom-most end of the shell pipe, both to minimize friction and to prevent soil from entering the pipe. Said system further comprises: a) an first portion of elongate shell pipe directly pushed into the pilot hole, said shell pipe closed at the bottom end; b) connecting first element of said shell pipe portion to second element of shell pipe portion and further directly pushing into the ground; c) repeating connection and direct push for subsequent elements until desired total insertion length has been reached; d) a U-tube assembly positioned within said shell pipe, further comprising a down pipe, an up pipe, and a U-turn element to conduct fluid from down pipe to up pipe with minimal flow restriction; e) a thermally-conductive material filling the volume between interior of said shell pipe and outer diameters of said down pipe and up pipes; f) a fluid pump serially connected to a flow-through heating apparatus capable of exchanging a calibrated thermal power with fluid moving through the pump; g) a fluidic connection between uppermost portion of said down pipe and said serially connected fluid pump and flow-through heating apparatus; h) a fluidic connection between uppermost portion of said up pipe and said serially connected fluid pump and flow-through heating apparatus; and i) means for measuring and recording fluid flow rate and both entering fluid temperature and leaving fluid temperature at multiple times during 1) charging of said heat exchange system and surrounding ground with thermal energy; and 2) discharging energy by diffusion away from heat exchange system and surrounding ground;

In a fourth embodiment, a heat exchange system for testing to determine effective ground thermal properties is disclosed, wherein a borehole having diameter greater than the diameter of follow-on shell pipe is formed in the ground. Said system further comprises: a) an elongate shell pipe assembled vertically into the ground and closed at the bottom end; b) c) a thermally-conductive material filling the volume between borehole and exterior of shell pipe; c) a U-tube assembly positioned within said shell pipe, further comprising a down pipe, an up pipe, and a U-turn element to conduct fluid from down pipe to up pipe with minimal flow restriction; d) a thermally-conductive material filling the volume between interior of said shell pipe and outer diameters of said down pipe and up pipes; e) a fluid pump serially connected to a flow-through heating apparatus capable of exchanging a calibrated thermal power with fluid moving through the pump; f) a fluidic connection between uppermost portion of said down pipe and said serially connected fluid pump and flow-through heating apparatus; g) a fluidic connection between uppermost portion of said up pipe and said serially connected fluid pump and flow-through heating apparatus; and h) means for measuring and recording fluid flow rate and both entering fluid temperature and leaving fluid temperature at multiple times during 1) charging of said heat exchange system and surrounding ground with thermal energy; and 2) discharging energy by diffusion away from heat exchange system and surrounding ground. The system further comprises analysis of entering fluid temperature and leaving fluid temperature at multiple times, including the steps of: A) defining a model representing the installed shell pipe, U-tube assembly, and fillers as a resistor-capacitor network with voltage at each node representing temperature; B) simulating based on said model a charging cycle followed by a discharging cycle, wherein during charging cycle constant heat input is applied for a specified time; while during discharging cycle heat input is halted while fluid circulation is continued and system response is monitored for a specified time; C) recording simulated values for both entering fluid temperature and leaving fluid temperature at multiple discharge times and a range of input values of thermal conductivity and volumetric heat capacity at each time; D) summarizing data for each discharge time in the form of a quadratic equation with thermal conductivity as the variable; E) applying quadratic formula to solve for effective ground thermal conductivity based on ratio of temperature at start of discharge time and temperature at subsequent time; F) solving for effective ground volumetric heat capacity based on chosen value for effective ground thermal conductivity.

In a fifth embodiment, an apparatus for testing to determine effective ground thermal conductivity and volumetric heat capacity is disclosed; wherein said apparatus comprises a shell pipe assembled vertically into the ground; a U-tube inserted or assembled into the shell pipe and configured to conduct fluid from an input side to a return side; a fluid pumping device; a flow-through heating device; two or more temperature sensors installed to detect at least the input side entering water temperature and return side leaving water temperature; and a device for measuring and recording temperature and flow rate data.

In a sixth embodiment, a method for testing of suitability of a site for an effective ground-based heat exchange system is taught, wherein a first element of a proposed ground loop system is assembled and connected to a) a fluid circulation pump; and b) a flow-through heating apparatus which is calibrated and controlled to inject heat into the circulating fluid. Preferably, a charging phase is completed by first operating the pump for a few minutes to establish stable flow rate and temperatures, then activating the flow-through heating apparatus and operating at constant power for a set time period to inject thermal energy into the circulating fluid. During this time period, thermal energy contributes to temperature rise in circulating fluid, and thermal energy then conducts and diffuses outward from the U-tube pipes, through the grout and other thermally-resistive elements and thence into the surrounding ground. During charging phase, mean temperature T_{MEAN}=(EWT+LWT)/2 slowly increases over time, approaching a steady-state value after several hours. The discharge phase is initiated by halting operation of the heating apparatus while continuing to operate the pump for an extended time. Temperatures EWT and LWT are measured and recorded at multiple times or continuously during both charging and discharging phases. Ground thermal conductivity κ_{GND} and volumetric heat capacity ρC_{P_GND} are found by performing detailed calculations or alternately by comparing times and temperatures to a previously calculated lookup table. With the ground properties established, the design is finalized and a decision made on the suitability of the proposed project at the specific site. The two possible outcomes from the decision are: 1) the project is judged to not meet minimum requirements and is abandoned; or 2) the project is judged to meet minimum requirements, the design details are finalized, and the project is continued with the first loop becoming part of a larger system.

In a seventh embodiment, a method for testing of suitability of a site for an effective ground-based heat exchange system is taught, wherein a first element of a proposed ground loop system is installed and connected to a) a fluid circulation pump; and b) a flow-through heating apparatus which is calibrated and controlled to inject heat into the circulating fluid. Preferably, a charging phase is completed by first operating the pump for a few minutes to establish stable flow rate and temperatures, then activating the flow-through heating apparatus and operating at constant power for a set time period to inject thermal energy into the circulating fluid. During this time period, thermal energy contributes to temperature rise in circulating fluid, and thermal energy then conducts and diffuses outward from the U-tube pipes, through the grout and other thermally-resistive elements and thence into the surrounding ground. During charging phase, the mean temperature T_{M}=(EWT+LWT)/2 slowly increases over time, approaching a steady-state value after several hours. Temperatures EWT and LWT are measured and recorded at multiple times or continuously during the charging phase. Methods for analysis of entering fluid temperature and leaving fluid temperature at multiple times, including the steps of: A) defining a model representing the installed shell pipe, U-tube assembly, and fillers as a resistor-capacitor network with voltage at each node representing temperature; B) simulating based on said model a charging cycle wherein constant heat input is applied for a specified time; C) recording simulated values for both entering fluid temperature and leaving fluid temperature at multiple discharge times and a range of input values of thermal conductivity and volumetric heat capacity at each time; D) fitting data for each charge time in the form of a sum of exponential terms; E) solving for effective ground thermal conductivity based on value of exponential terms; F) inputting extracted value of ground thermal conductivity and calculating volumetric heat capacity ρC_{P_GND}. With the ground properties established, the design is finalized and a decision made on the suitability of the proposed project at the specific site. The two possible outcomes from the decision are: 1) the project is judged to not meet minimum requirements and is abandoned; or 2) the project is judged to meet minimum requirements, the design details are finalized, and the project is continued with the first loop becoming part of a larger system.

### BRIEF DESCRIPTION OF THE SEVERAL VIEWS OF THE DRAWINGS

FIG. 1 is a summary of thermal to electrical analogies.

FIG. 2 is a circuit schematic explicitly showing resistance and capacitance elements to represent each circuit segment. Voltages, the analog of temperature, are labelled at each node. All capacitances are correctly tied to circuit ground.

FIG. 3 is a prior art version of a purely resistive circuit schematic. A first voltage supplies the temperature T_{HIGH}, while a second voltage supplies the temperature T_{LOW}. Pipe resistance components convection resistance and conductive resistance are lumped into resistances r_{PIPE1} and r_{PIPE1}. Resistances r_{GROUT1} and r_{GROUT2} are shown separately for each leg. A key feature of this schematic is the representation of shunt resistance r_{SHUNT} as a single, simple, resistance. Resistance of the ground or soil is shown as r_{SOIL}, which varies over time. Currents flow towards T_{GROUND}.

FIG. 4 is a circuit schematic based on FIG. 3, following a delta-to-wye conversion. New resistances R_{A}, R_{B} and R_{C} are calculated to enable conventional series-parallel resistive circuit analysis.

FIG. 5 is an alternate circuit diagram prepared for implementation using SPICE, representing a 2D slice of the U-tube ground loop somewhere along the length. A single voltage T_{AVERAGE} supplies the temperature, and is switched ON and OFF by a single-pole-single-throw (SPST) switch actuated by a separate pulsed voltage supply. The thermal ground resistance is modeled as N each RC segments.

FIG. 6 is a simplified illustration of a test-in-place system, showing the U-tube connected to a flow-through heating apparatus, along with pump and both flow control and purge valves.

FIG. 7 is an example illustration of the time evolution of V1 when applying the system shown in FIG. 6. V1 represents the temperature at the edge of the borehole, as a ground loop is charged with heat at a constant input power. The illustration is based on output from multiple simulations with T_{AVERAGE}=13.75. Ground thermal conductivity κ is shown as a parameter, with three values of 0.8, 2.0 and 3.2 W/m-° K. In FIG. 7, steady-state is reached at about 336 hours (two weeks), while 98% of steady-state voltage is reached at 60 hours.

FIG. 8 is an example plot of voltages V(In) and V1 over time. At time t=0 voltage V(In) is instantaneously switched from 0 to 13.75 volts. Voltage V(In) rapidly reaches 13.75V following turn-on at t=0. At time t=216,000 seconds (60 hours), voltage is instantaneously switched from 13.75 to 0 volts. Following turn-off, voltage V(In) rapidly falls until it is almost equal to voltage V1., while voltage V1 falls in a multi-exponential fashion.

FIG. 9 is a table of model parameters used for 8 different designs. For a given value of grout thermal conductivity κ_{GROUT}, resistance and capacitance values are shown along with calculated BTR.

FIG. 10 is a plot of Calculated Conductivity Range as a function of discharge time for six different designs. Importantly, Calculated Conductivity Range either crosses zero (0) or is projected to cross zero for each modeled design. At zero-crossing, effective ground thermal conductivity κ_{GROUND} is calculated with maximum accuracy.

FIG. 11 is a plot of simulated quotient Q(t) as ground Thermal Conductivity κ and Volumetric heat capacity are varied. The design includes a conventional HDPE U-tube in 6″ diameter borehole, with spacing 0.1 m and ideal geometries assumed. Charge time is 60 hour and discharge time is 1.0 hour. The plot illustrates that quotient Q(t) varies nonlinearly with κ and varies significantly with the value of volumetric heat capacity ρC_{P}.

FIG. 12 is a plot of simulated quotient Q(t) as ground Thermal Conductivity κ is varied for the same design as used in FIG. 11. However, both borehole diameter and pipe spacing are additionally included. Charge time is 60 hours and discharge time is 1.0 hour. The plot illustrates increased variation of quotient Q(t) as geometry variation is included.

FIG. 13 is a plot of simulated quotient Q(t) as ground Thermal Conductivity κ and Volumetric heat capacity are varied. The design uses 2-⅜″ diameter steel shell pipe with copper U-tubes. with spacing held constant, and κ_{GROUT}=2.0. Charge time is 60 hours and discharge time is 1.0 hour. The plot illustrates that variation of quotient Q(t) is significantly reduced for the steel and copper design.

FIG. 14 is an illustration of identically the same system as in FIG. 13, but evaluated at 8 hour discharge time. The plot illustrates that variation of quotient Q(t) is significantly increased at longer discharge time.

FIG. 15 is an illustration of identically the same system as in FIG. 13, but κ_{GROUT}=0.6 and temperature is evaluated at ideal 1.6 hour discharge time. The plot illustrates that variation of quotient Q(t) is almost independent of ρC_{P} at this specific discharge time and with lower κ_{GROUT}.

FIG. 16 is an illustration of identically the same system as in FIG. 15, but with HDPE pipes instead of copper pipes. Again, temperature is evaluated at ideal 1.6 hour discharge time. The plot illustrates that with replacement of pipe material quotient Q(t) remains almost independent of ρC_{P} at this specific discharge time and with κ_{GROUT}.=0.6.

FIG. 17 is a lookup table for the conventional single HDPE U-tube in a 6″ diameter borehole with ideal pipe spacing of 0.1 m (3.96 and κ_{GROUT}=2.0 W/m-° K. The heat exchange system is charged for 60 Hours with T_{AVERAGE}=13.75.

FIG. 18 is a lookup table for an unconventional 2⅜″ diameter steel shell pipe with copper U-tubes having pipe spacing of 0.027 m and κ_{GROUT}=0.6 W/m-° K.

FIG. 19 is a plot of simulated charging voltage vs. natural logarithm of time for a conventional system. In FIG. 19A, thermal conductivity is a parameter, while in FIG. 19B volumetric heat capacity is a parameter. The plot illustrates that Charging Voltage varies significantly with both thermal conductivity and volumetric heat capacity. This illustrates the limitation with conventional methods of analyzing charging temperature vs. time to estimate ground thermal conductivity.

### DETAILED DESCRIPTION OF THE INVENTION

The invention enables accurate determination of effective ground thermal properties by a) making design choices on elements contributing to improved consistency and reproducibility of borehole thermal resistance (BTR); b) finding effective ground thermal conductivity at a specific discharge time when the discharge ratio Q(t) is nearly independent of volumetric heat capacity; and c) finding volumetric heat capacity by making use of the recently found thermal conductivity at a second discharge time when the discharge ratio Q(t) is significantly dependent on volumetric heat capacity. Improved consistency of BTR is accomplished largely by use of a high thermal-conductivity, small-diameter shell pipe. Due to small diameter, the volume filled with grout is significantly reduced and the conductive resistance component due to grout is much smaller. Optionally, the U-tubes are constructed from internal pipes also having high thermal-conductivity.

Prior art thermal response testing (TRT) relies on installation of a ground loop dedicated to the purpose of making inferences on ground thermal properties. There are two issues with this approach. First, the error bars on extracted ground thermal properties increase significantly when estimates of BTR are incorrect; and second, error bars increase to the extent that the TRT ground loop does not exactly mimic the follow-on ground loop installation.

Prior art is largely based on charging the ground loop with heat and applying curve-fitting methods to infer the surrounding ground properties based on the time and temperature profile during charging. In the typical test procedure, a controlled input rate of heat energy is applied to the fluid in the U-tubes over a specific time period. The recommended time period of 48-72 hours is large enough that short-time effects of charging the fluid and grout are minimized. With this approach, it is necessary to used estimated values for BTR as an input to the calculations.

With the inventive system and method, the temperature may be monitored both during the charging time period when constant heat flux is applied and during the follow-on discharging period when heat flux is zeroed and the temperature drifts back towards the undisturbed temperature. This latter period is herein termed discharge, but is sometimes called “recovery”. Ground parameters can then be extracted by curve-fitting methods from the temperature-time profiles obtained both during charging and discharging. Alternatively, advantage is shown in first extracting information on ground thermal properties by fitting the discharge curve at one or more precise discharge times, then validating this information by fitting the charging curve.

In support of required charging times, simulations based on an RC circuit show that regardless of the exact ground properties the temperature of the circulating fluid reaches steady-state within about 2 weeks under constant heat load. From SPICE (Simulation Program with Integrated Circuit Emphasis) modeling of both conventional HDPE-based single and double U-tubes, the fluid temperature reaches minimum 98% of the steady-state values after about 54 hours. Time to approach steady-state is longest when both thermal conductivity and volumetric heat capacity are high. By comparison, with an unconventional high-thermal conductivity U-tube place in a high-thermal conductivity shell pipe, 98% of steady-state temperature is reached in about 45 hours. This is due to the unconventional shell pipe having smaller diameter and lower thermal capacitance.

Interestingly, simulations show that the temperature reached at steady-state is linear with the ground thermal conductivity. Therefore, thermal conductivity can be immediately estimated following a 2-3 day heat cycle. Unfortunately, this first estimated value varies about +/−20% due to unknowns in volumetric heat capacity, and even more due to variations in installation geometries. A more precise estimate of ground thermal properties is demanded.

Heat circulating through a test ground loop is first exchanged with the BTR and then diffuses into the ground. Analogous to an electrical voltage divider, a portion of the temperature is dropped across the BTR and the remainder across the ground resistance. With prior art design, BTR amounts to about 0.05-0.2 m-° K/W. Ground resistance begins at zero, but rapidly increases to a steady-state value when heat is continuously applied. For 0.8<κ<3.0, R_{GND} at 2 weeks might range from about 0.16-0.48 m-° K/W. Therefore, between about 24-56% of the temperature is dropped across BTR depending on the unknown ground thermal properties. This variation highlights the dependence of extracted ground properties on value of BTR.

In the limit with minimal grout volume, BTR is reduced to the combination of pipe convection resistance and pipe conduction resistance. In such case, BTR might be reduced to about 0.01 m-° K/W, with about 2-5% of the temperature dropped across BTR. The same design changes that lead to BTR minimization also result in near-perfect BTR repeatability.

Modeling of both BTR and ground resistance is improved by developing an electrical analog method for transient and steady-state heat flow analysis. Readily-available electrical analysis tools then enable rapid, accurate simulations. In particular, SPICE modeling of equivalent electrical RC circuits is very effective. While not required by the invention, electrical analogy and SPICE simulation are discussed herein since they allow for more intuitive description of the problem and test results, and for comparisons based on rapid simulations of various designs. In particular, SPICE simulation is very well suited for reduced or variable duty cycle analysis.

One aspect of the invention relates to analysis of discharge of the heat energy stored in the ground following a preceding charging phase. The difficulty of such analysis is dramatically reduced by first introducing an electrical RC analogy of the thermal problem, then applying SPICE modeling.

### Electrical Analog Method for Transient and Steady-State Heat Flow Analysis

The basic “Heat Exchanger equation” is:

$$\\ \begin{matrix}Δ {T}_{m} = Q / UA ; or Q = ( U * A ) * Δ {T}_{m} & Equation 3\end{matrix}$$

where Q is the heat transfer rate in kWatt or kJoule/sec (or BTU/hr)
   ΔTₘ is the log mean temperature difference between Source and Sink in ° K
   U is the overall heat transfer coefficient in W/m²-° K
   A is the overlap area between Source and Sink in m²
      (typically πr² for a cylindrical pipe)

The heat flow equation can be better understood by considering an analogy to Ohm's Law in DC electrical circuits: V=I*R. With this analogy, temperature difference ΔTₘ is a driving force similar to the voltage in electrical circuits.

The U-value (abbreviated “U”) is normally applied to quantify the rate of thermal transmittance of heat energy through matter in units of W/m²-° K. Since U is defined in terms of “ability to transmit heat per unit area”, it must first be multiplied by area to develop an analogy to electrical resistance. In fact (1/UA), the inverse of UA, is considered as “thermal resistance”.

Heat flow rate q is similar to the electrical current. Specifically for geothermal boreholes filled with pipe, calculation of heat flow q in units of W/m is a key desired outcome. Given a design objective of rejecting a given amount of energy per unit time, or power (units of Watts), the required total design length is immediately found by determining q.

Necessary for the calculation is the measured value of ΔTₘ in units of ° K, where the subscript “m” indicates mean value determined by averaging over the length of the U-tube. Entering water temperature (EWT) and leaving water temperature (LWT) are each defined relative to the constant ground temperature. Assuming that temperature drops linearly along the length of the U-tube, a useful simplification is that:

$$\\ \begin{matrix}Δ {T}_{m} = \frac{EWT + LWT}{2} & Equation 4\end{matrix}$$

Obviously, the equation ΔTₘ=q*(1/UA), where q is in units of Watts, maps to electrical V=IR.

Resistance in electrical terms can be written to include geometry as:

$$\\ \begin{matrix}R = \frac{l}{σ A} ; where σ is the conductivity , & Equation 5\end{matrix}$$

$$\\ 1 is the conductor length , A the area of the resistor$$

The Ohm's Law analogy can be extended, with electrical length 1 mapping to layer thickness t for thermal; A is the overlap area in both cases. Electrical conductivity σ maps to thermal conductivity κ, and keeping that electrical resistance maps to (1/UA) for thermal resistance:

$$\\ \begin{matrix}\frac{1}{UA} = \frac{t}{κ A} ; or U = \frac{κ}{t} ; giving & Equation 6\end{matrix}$$

$$\\ Δ {T}_{m} = Q * \frac{1}{UA} = Q * \frac{t}{κ A} ; or Q = \frac{κ A}{t} * Δ {T}_{m}$$

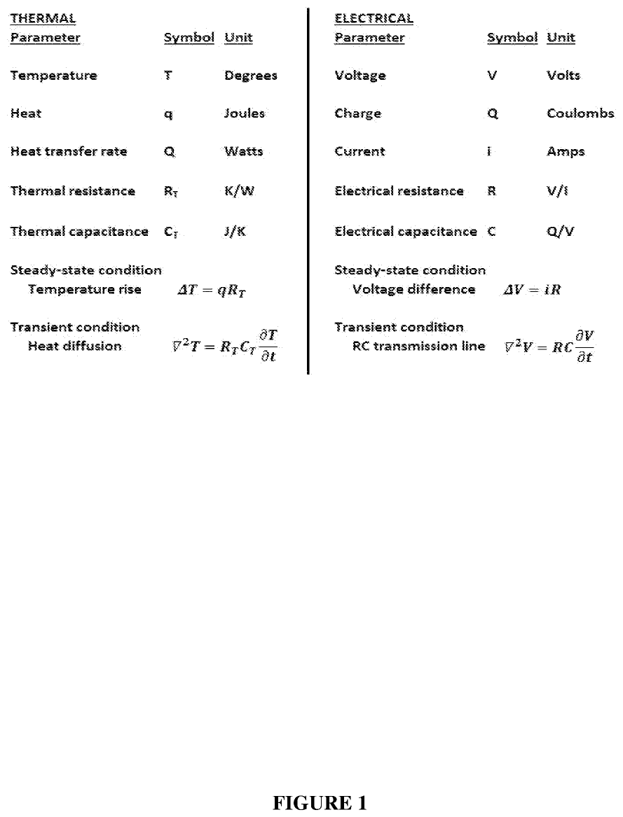

The thermal-to-electrical analogy is very useful since it enables drawing of simple electrical schematics and application of well-developed tools to determine voltages (temperature) and currents (heat flow) at each node. The various analogous parameters are summarized in FIG. 1.

Analogies of thermal resistance based on electrical resistance are easily developed. Thermal capacitance, or the ability to store thermal energy, is analogous to electrical capacitance. It must be emphasized that while a thermal circuit can be modeled as comprising resistances and capacitances (an RC network), the analogy is imperfect since it is not physically possible to connect an annular ring of thermal capacitance to the temperature of the surrounding ground at undisturbed temperature. Furthermore, simple series/parallel circuits might incorrectly result in direct current blocking capacitance in some cases. The only possible response is to build an analogous electrical model with each capacitor connected directly to electrical ground. In effect, the thermal capacitance of each annular ring “jumps over” the intervening rings between it and the undisturbed ground temperature, which serves the role of electrical ground.

For reference, modeling of thermal capacitances each tied to ground is solidly supported. From network theory specific to RC networks, a “Foster circuit” has each capacitor in parallel with a resistance; while a “Cauer circuit” has each capacitor tied to electrical ground. A Foster circuit can be converted to a Cauer circuit by canonical transformation. Therefore, the two circuit types may be used interchangeably, with some care taken to correctly define resistance and capacitance values. To be clear, with transformation from Foster to Cauer network, individual resistance and capacitance values are completely different.

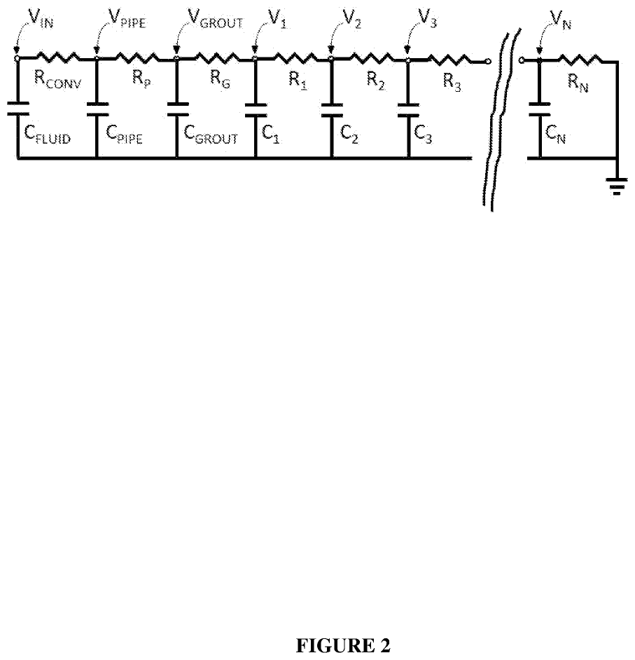

Successful definition of electrical analogies for thermal properties enables use of electrical circuit schematics. A circuit schematic based on an RC model is shown in FIG. 2. Multiple resistances and capacitances are represented with this initial version. Beginning with V_{IN}, the voltage is labeled at multiple nodes. Resistances include R_{CONV}, the convective resistance of the pipe; R_{P}, the conductive resistance of the pipe; and R_{G}, the conductive resistance of the grout. Next, the ground impedance is represented as N elements labeled R₁ to R_{N}, each consisting of a series resistance and capacitances labeled C₁ to C_{N} each tied to electric ground.

For the analogous thermal-electrical circuit, series and parallel resistances and impedances are treated the same as electrical resistances and impedances.

An important step for modeling is to “partition” the surrounding ground into multiple stages. A single stage with a large capacitance would incorrectly show only slight net current flow to ground while the capacitor is charging. Partitioning into only three stages still shows some of this effect. Best partitioning includes a sufficient number of partitions to most accurately represent real current flows, while avoiding excessive complexity. Based on simulations discussed below, acceptable accuracy is achieved by dividing the surrounding ground into 15 segments.

For simplicity in programming circuit values representing the ground, it is remarkably convenient to make the resistance values of each of multiple stages identically the same. To implement this, the resistance R; of each stage, a constant for all stages, is calculated as:

$$\\ \begin{matrix}{R}_{i} = ln ( \frac{{r}_{i} + 1}{{r}_{i}} ) / 2 π {κ}_{GND} & Equation 7\end{matrix}$$

From general theory the “diffusion length” D is defined as the square root of the product of thermal diffusivity and diffusion time: D=\sqrt{αt}; where thermal diffusivity α=κ/ρC_{P} and t is time. The maximum penetration of a diffusion can then be defined as r_{MAX}=m\sqrt{αt}, where m is a multiplier. With N stages between initial radius r_{BORE} and final radius r_{MAX}, a constant C_{SELECT} is defined such that:

$$\\ \begin{matrix}{C}_{SELECT} = \frac{{r}_{i + 1}}{{r}_{i}} = {[ \frac{m \sqrt{α t}}{{r}_{BORE}} ]}^{( \frac{1}{N} )} = {[ \frac{mD}{{r}_{BORE}} ]}^{( \frac{1}{N} )} & Equation 8\end{matrix}$$

where r_{BORE} is the radius of the borehole, or alternatively the radius at which the installed apparatus ends and the surrounding ground begins

Again from general theory, a good initial guess is that m=3, corresponding to three diffusion lengths, and r_{MAX}=3D. However, in agreement with the infinite line source model and many simulations, the choice is made that m=1.5.

$$With this definition , \text{} {R}_{i} = ln ( {[ \frac{1.5 D}{{r}_{BORE}} ]}^{( \frac{1}{N} )} ) / 2 {πκ}_{GND} = \frac{1}{2 π N {κ}_{GND}} ln ( \frac{1.5 \sqrt{α t}}{{r}_{BORE}} ) \qquad Equation 9$$

The same radii and ratio determined for uniform resistance values is also useful for calculation of capacitance values. The capacitance of the first stage is determined by the ratio of radius r_{BORE} to the next radius, as well as by the ground constants. The equation for capacitance of the first segment C₁ is given as: C₁=ρCₚπ(r₂²−r₁²)=ρC_{P}π(r₂²/r₁²−1)*r₁², where r₁=r_{BORE}; ρ is the ground density; Cₚ is the specific heat of the ground.

Generalizing and substituting

$${C}_{SELECT} = \frac{{r}_{i + 1}}{{r}_{i}}$$

gives:

$${C}_{i + 1} = ρ {C}_{P} π ( {C}_{SELECT}^{2} - 1 ) * {r}_{i}^{2} ; \text{} and \frac{{C}_{i + 1}}{{C}_{i}} = \frac{{r}_{i}^{2}}{{r}_{i - 1}^{2}} = \frac{{r}_{i + 1}^{2}}{{r}_{i}^{2}} = {C}_{SELECT}^{2} \qquad Equation 10$$

The formula for successive capacitance values is simply:

$${C}_{i + 1} = ( {{C}_{SELECT}}^{2} ) * {C}_{i} \qquad Equation 11$$

With these assignments of values for Rᵢ and Cᵢ, circuit values representing the ground are easily calculable. Note that through the dependence of D on time, radii vary with time. This is not a problem for analysis at a single, specific time. However, to perform analysis of the diffusion profile at two or more times, a decision must be made on whether to assign static values of radii that are sufficiently large to encompass the longest time to be studied, or to vary the radii and therefore the ground resistances and capacitances for each time period. The first approach is recommended for obtaining the most representative results, but results in a demand to increase the number of stages simulated in order to adequately represent the problem at short times. Therefore, N=30 is recommended when static values of radii are assigned. A useful approach is to select static values of the RC circuit based on the time to reach steady-state. For most problems this is adequate for calculation at times less than steady-state.

The conductive resistance and the capacitance of the pipe Rₚ is simply calculated as:

$${R}_{P} = ln ( {r}_{OUTER} / {r}_{INNER} ) / 2 {πκ}_{PIPE} ; \text{} {C}_{P} = {( ρ {C}_{P} )}_{PIPE} π ( {r}_{OUTER}^{2} - {r}_{INNER}^{2} ) \qquad Equation 12$$

The closed-form formula for the conductive resistance of the grout R_{G} is taken from Bennet 1987, and is complex and not repeated herein. The capacitance value C_{G} is estimated in simplest form, based on the volume occupied by the grout and the assumed materials properties. The energy storage capacity of the grout is typically small compared to the ground.

The convective resistance R_{CONV} is a small contributor as long as the fluid flow rate is sufficiently high. In fact, R_{CONV} can be set at a low value as a matter of policy by fixing the fluid flow rate. Therefore, for simplicity R_{CONV} and R_{P} are lumped together below to represent the total pipe resistance.

The thermal to electrical analogies have been specified above, with both resistances and capacitances selected in a manner that enables rapid adjustment supporting execution of simulation matrices.

For best accuracy calibration of circuit values representing thermal capacitances is required. Calibration is done by employing the boundary condition that all energy exchanged into the modeled system must be stored within the volume defined by the U-tube exterior surfaces and r_{MAX}. According to the infinite line source model, thermal energy does not diffuse beyond r_{MAX} at the specified time. For example, from independent study not presented herein, multiplicative capacitance calibration factor Cc averages about 10.2 in steady state.

SPICE modeling of Equivalent Electrical RC Circuits

SPICE has long been applied to analysis of electrical circuits. The semiconductor industry developed SPICE models, and unsurprisingly the same industry has occasionally applied SPICE analysis for thermal modeling. Strickland's 1959 analysis is one example. More recently, contribution by Gerstenmaier et al, 2007 is one often-cited treatment setting an example.

Unlike other methods, transient analysis is straightforward when using SPICE modeling. This is an enormous advantage. The simplicity of the SPICE tool allows for rapid iteration, leading to ready development of intuition about design tradeoffs. This is especially important when performing transient analysis, or for less than 100% duty cycle.

To begin using SPICE for thermal analysis, analogies are adopted as above. Perhaps the most important payoff from thermal modeling of ground-loop heat exchangers is prediction of q, the exchange power per unit length, for example in units of Watts/meter. This leads directly to determination of optimum ground loop lengths.

With electrical circuits, power P in units of Watts is found as P=V*I (voltage*current). However, with thermal analogy where temperature replaces voltage, q replaces electrical current, and the Heat Transfer Rate (HTR) is in units of Watts. Therefore, rather than mimicking electrical circuits by multiplying Temperature by HTR to determine power, the value of the HTR itself is the answer being sought. In fact, thermal resistance R_{TH} per unit length of borehole has units of m-° K/W, while HTR has units of Watts/meter.

SPICE modeling begins by drawing the equivalent circuit schematic. A graphic tool is available for schematic construction. A netlist, extracted from this schematic, summarizes the individual nodes, their interconnections, and the circuit values. Note that the SPICE model can be exercised using the netlist by itself, although the schematic cannot be easily back-generated from the netlist.

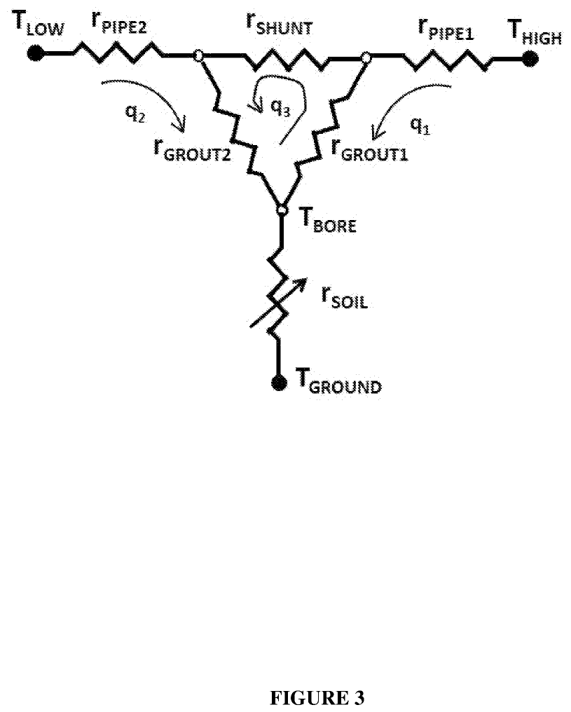

An initial prior art schematic is illustrated in FIG. 3, employing an electrical equivalent resistance model of the borehole and ground. This schematic represents a 2D slice at some point along the length of the U-tube. Pipe resistance components convection resistance and conductive resistance are lumped into resistances r_{PIPE1} and r_{PIPE1}. Resistances r_{GROUT1} and r_{GROUT2} are shown separately for each of down-going and up-coming legs. A key feature of this schematic is the representation of shunt resistance r_{SHUNT} as a single, simple, resistance. Resistance of the ground or soil is shown as r_{SOIL}, which varies over time. Currents flow towards T_{GROUND}.

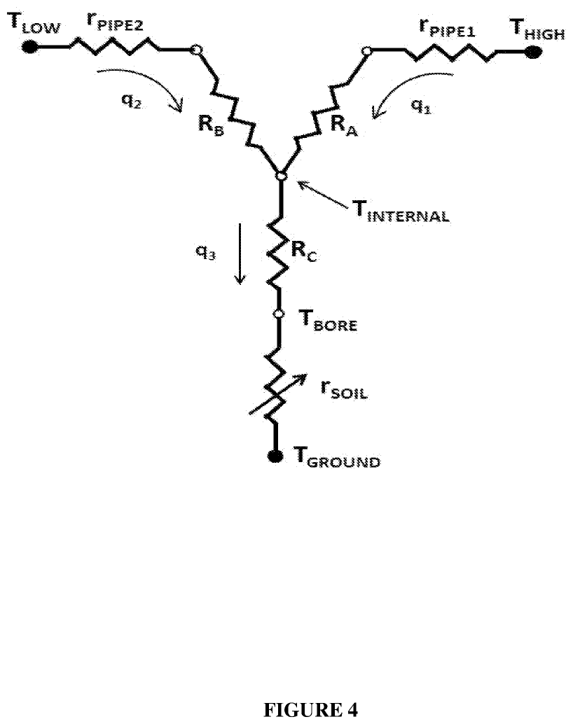

In FIG. 4, a Delta-to-Wye transformation of the circuit in FIG. 3 is shown. Although not detailed herein, such transformation is made by calculating new resistances R_{A}, R_{B} and R_{C}. This circuit is included for completeness, although the argument is advanced below that inclusion of r_{SHUNT} for SPICE modeling is an unnecessary complication.

The three reasons that shunt resistance can be neglected are: 1) In practice, the voltage difference between nodes representing adjacent down and up pipe segments is small; 2) heat cannot flow uphill, and slightly off the centerline drawn between two adjacent pipes the voltage in many practical situations drops too low to allow any current flow at all; and 3) shunt current is at least partially beneficial, since it slightly increases the voltage in the adjacent leg, thereby providing more driving force for exchange with the ground. It is worth noting that the ground heat exchangers of the “concentric” design historically preceded the U-tube design, and with concentric design shunt effect directly results in reduced performance. For this reason, a great deal has been written about shunt effect in U-tubes. Regardless, modeling shunt effect in U-tubes introduces complexity, with little or no payoff. In fact, beginning with the circuit illustrated in FIG. 3, in the limit of shunt resistance approaching infinity this circuit incorrectly results in r_{GROUT1} and r_{GROUT2} being in parallel. A more representative circuit is developed by simply ignoring r_{SHUNT}, and recognizing that the down-going and up-coming pipes act almost independently but with different average temperatures. Therefore, a single pipe adequately models the full circuit with T_{AVERAGE}, the average of T_{HIGH} and T_{LOW}, providing the best approximation.

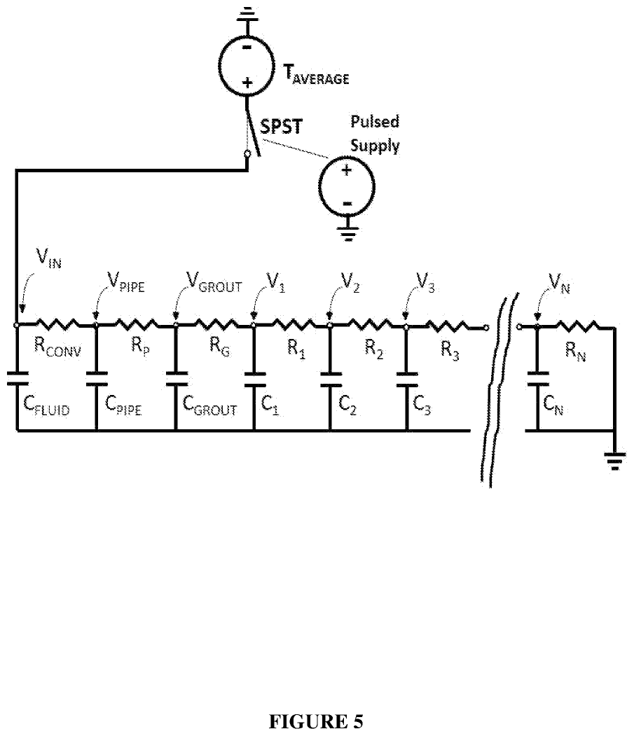

The circuit shown in FIG. 5 is used for SPICE simulations and analysis. T_{AVERAGE}, the mean of EWT and LWT, is treated as the single source of heat energy. A single-pole-single-throw (SPST) switch is included. The switch is controlled by a separate voltage supply, which may supply either constant or pulsed voltage. Capacitive elements, each tied to circuit ground, are included for C_{FLUID}, C_{PIPE}, C_{GROUT}, and C₁ to C_{N}. Each capacitance is correctly shown as being tied to electrical ground. The shunt resistance included in prior art schematics is neglected. Overall, the surrounding ground is represented as N each RC stages.

In common with the prior art circuit shown in FIG. 3, the circuit in FIG. 5 does not correctly account for obscuration of a first pipe by a second pipe. That is, neither down-going nor up-coming pipe can freely radiate thermal energy in all radial directions due to obscuration by the adjacent pipe. The implication is that simulations based on either circuit do not correctly predict Q/L. However, adjustment for obscuration effect is easily made after completing simulations.

Inclusion of the SPST switch and controlling pulsed voltage source sets the stage for varying duty cycle during transient analysis. Another key benefit of SPICE modeling is that all node voltages can be saved from a given simulation and introduced as the starting voltages in a subsequent simulation.

### Testing Approach: Determining Ground Thermal Conductivity and Volumetric Specific Heat

The most commonly used testing approach for determining ground thermal conductivity and volumetric specific heat is based on charging with thermal energy while monitoring EWT and LWT. A less commonly applied approach is to first thermally charge the system and to then observe the discharge. Both approaches are discussed below.

Prior art has primarily focused on the experimental approach of initially “charging” the system to a relatively known state, halting charge and monitoring circulating fluid temperatures vs. time following charge. Recorded data is applied to a proposed model and ground properties are varied to “best fit” the observed temperature versus time curve. In addition, some prior art makes use of temperature vs. time data as the system discharges or recovers from charging. Such prior art fails to recognize that for a given design there is a specific time when the discharge to that point is nearly independent of variation in ground volumetric heat capacity ρC_{P_GND}.

The inventive method for determining ground properties to within certain bounds is summarized as:
a) simulating system charging over a range of variables;
b) simulating system discharge over time and over the range of variables;
c) summarizing system discharge over time in equation form;
d) solving the equation for thermal conductivity using a mean value of volumetric heat capacity;
e) using extracted value of thermal conductivity to solve for final value of volumetric heat capacity.

Importantly, extraction of thermal conductivity κ_{GND} is done with maximum accuracy at the specific time when discharge to that point is nearly independent of ground volumetric heat capacity ρC_{P_GND}.

### Charging by Circulating Heated Fluid for a Set Time Period

Charging is accomplished by forming fluidic connections to the U-tube, then circulating fluid at a constant flow rate through a heating apparatus set for constant input power. Heat entering the U-tube loop first exchanges from pipes to grout within the borehole, then diffuses into the surrounding ground. For example, a water-antifreeze mixture circulating at 5 gallons per minute might be heated by a constant 10 kW power source, and both EWT and LWT monitored over time. The water in the loop quickly approaches a stable temperature distribution, with average temperature as the mean of EWT and LWT. As heat is exchanged, the system approaches steady-state over several hours.

It is critical that the power input to the ground loop is both stable and well-known. For the charging phase, it is important that the circulating fluid be thermally isolated such that heat loss mechanisms occurring above ground are minimized. For example, the power source must have excellent insulation and all circulating fluid conduits must be very close to the ground surface. Note that for the discharge phase discussed below, the circulating fluid may be switched away from the power source to minimize influence of residual heat stored in the heating apparatus itself.

Simulations allow for prediction of the voltage at each node as a function of time. For convenience, voltage V1 in FIG. 5 is defined as analogous to temperature T_{BORE} in FIGS. 3 and 4. V1, representing temperature at the borehole edge, is tracked to determine onset of steady-state condition. For the ground loops studied and the full range of input variables of practical interest, the ground-based heat exchanger system approximately reaches steady-state after 2 weeks of constant flow and constant power input. This is easily verified by simulations at even longer times. Using 2 weeks as the benchmark, the ratio of voltage V1 at any shorter time to the voltage at steady-state can be determined.

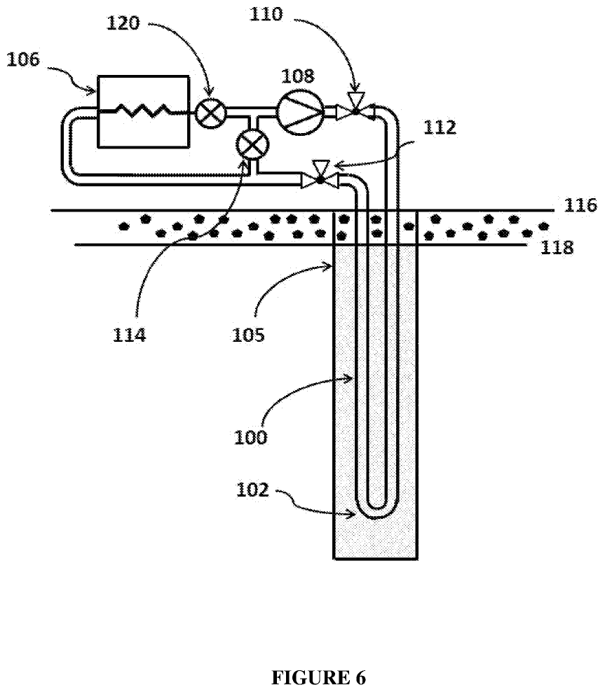

FIG. 6 is an illustration of a conventional ground-based heat exchange system. A U-tube 100 is inserted into a Borehole 105, which is then filled with Grout 102. Heating apparatus 106 sources thermal energy into fluid that is forced into circulation by Pump 108. First valve from purge tank 110 and second valve to purge tank 112 are included to enable system startup. Ground surface 116 is subject to temperature variation in response to atmospheric conditions and solar insolation. Constant temperature zone 118 is roughly 15 feet below Ground surface 116. Valve 110 and value 112 are included to allow for initial purging of the U-tube before filling with fluid. Also shown are Optional Heater bypass valves 114 and 120, enabling rapid isolation of the heat source at the conclusion of the charging phase while maintaining capability to circulate fluid. Effectively, in such case the thermal storage of the heating apparatus itself is bypassed.

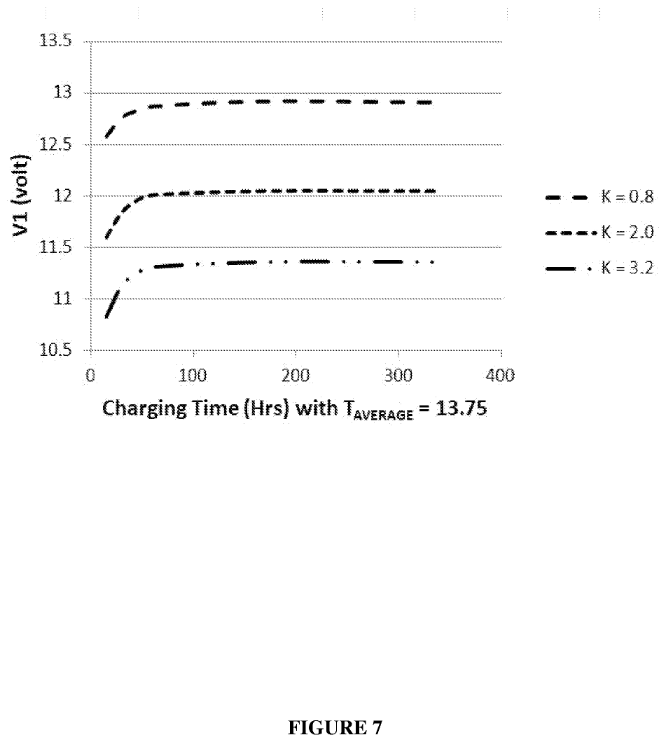

The conventional ground-based heat exchange system illustrated in FIG. 6 is adopted for use with charging according to the inventive system, methods and apparatuses. Employing this system FIG. 7 is an illustration of an example where V1 approaches steady-state temperature over time as the ground loop is charged with heat at a constant input power. Results displayed in FIG. 7 are based on many completed simulations assuming EWT=15° C. and LWT=12.5° C., such that charging temperature T_{AVERAGE} in FIG. 5 is 13.75° C. Thermal conductivity κ is shown as a parameter, with three discrete thermal conductivity values of 0.8, 2.0, and 3.2 W/m-° K. From this example, steady-state is apparently approached at roughly 50 hours.

From simulations specific to a conventional U-tube, it is found that a 60 hour charging time is required to bring the system to within at least 98% of the steady-state temperature at node V1. This is true for any practical choices of thermal conductivity and volumetric heat capacity. For comparison, similar onset of steady-state in an unconventional 2-⅜″ diameter steel shell pipe with ½″ copper U-tubes occurs at about 30 hours of charging. This reduction in time to reach steady-state is due to both lower BTR and lower thermal capacitance for the steel shell pipe design.

It is not explicitly required that the system be charged to steady-state. However, as total input energy (input power multiplied by time) increases the maximum radius reached by diffusing heat also increases, enabling “sampling” of radii farther from the borehole. In addition, discharge times are lengthened as total input energy increases, and effects of short time constants and transients due to input power start and stop are minimized. For these reasons, charge time of 60 hours for conventional systems is recommended. Such charge time is consistent with ASHRAE recommendations for testing of ground properties, although the recommended method does not include monitoring discharge. Charge time is optionally decreased to 30 hours for the unconventional 2-⅜″ diameter steel system. A 30 hour charge time has the practical value of reducing labor costs for test completion.

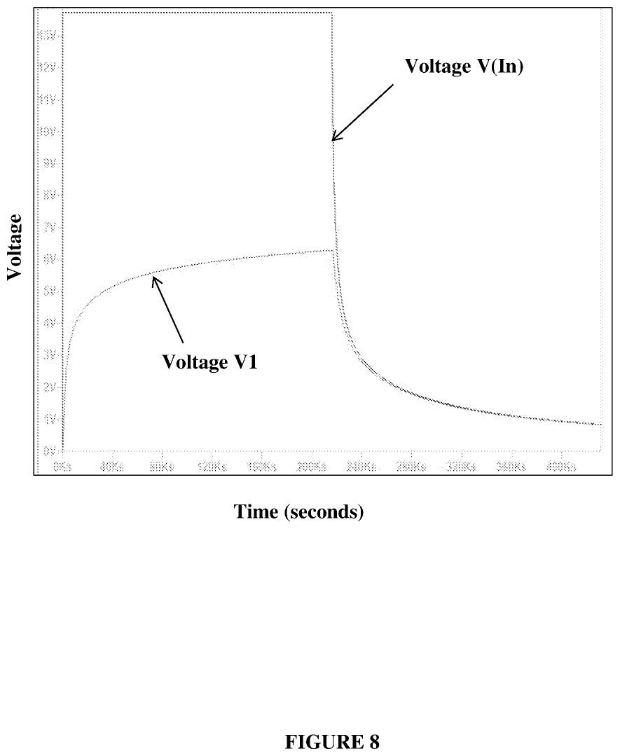

Voltage V(In) is defined as analogous to temperature of the fluid circulating in the U-tube. FIG. 8 is an illustration of the simulated V(In) over time during both charging and discharging in a conventional HDPE-based system. Simulated voltage V1 at the borehole edge is also recorded. At time t=0, a continuous 13.75 volts is supplied to the circuit. At time t=216,000 seconds (60 hours), the voltage source is switched off and the fluid temperature V(In) drops very rapidly until at 324,000 seconds (90 hours) it is just slightly higher than voltage V1. As discharging continues over time, V(In) becomes indistinguishable from V1.

Discharging while Circulating Fluid for an Extended Time Period without Additional Heat Input

To initiate discharge, heating apparatus 106 that has been constantly active throughout the charging cycle is switched off while pump 108 continues to circulate fluid. Bypass valves 114 is opened while bypass valve 120 is closed such that the flow-through heating apparatus is isolated from the fluid. In effect, the circulating fluid is now used as a passive sensor to monitor the decay of temperature within the system as heat diffuses outward. Again, EWT and LWT are measured and recorded over time.

Common sense suggests that when ground thermal conductivity is high (ground resistance is low), the temperature at the borehole edge rises more slowly during charging, and that discharge after removal of heat source occurs more rapidly. It seems clear that thermal conductivity κ is a primary variable affecting discharge rate.

Similarly, when volumetric heat capacity ρC_{P_GND} is high, more energy is required to charge the capacitances, and temperature at every node in FIG. 5 rises more slowly. Contrary to the case for thermal conductivity, discharge might be expected to also occur more slowly when ρC_{P_GND} is high. With high ρC_{P_GND}, calculated ground capacitances are increased. In fact, simulations show that for any specific borehole design the effect of ρC_{P_GND} on discharge rate is complex and varies with discharge time itself.

To be more specific, shortly following initiation of discharge, discharge rate is often anti-correlated with volumetric heat capacity ρC_{P} (depends on the exact system). At longer discharge times, discharge rate is correlated with ρC_{P}. This means a zero crossing must exist, where discharge ratio Q(t) is nearly independent of the value of ρC_{P}. Such zero crossing presents a key opportunity to select an optimum discharge time where ρC_{P_GND} has minimal impact, enabling more accurate determination of thermal conductivity κ at that point in time. The inventive zero crossing concept is explored in more detail below.

Range in calculated thermal conductivity is defined as the calculated conductivity κ_{GND} at highest ρC_{P_GND} minus the calculated conductivity at lowest ρC_{P} for each specific design. With conventional HDPE design, the range is large and negative at short discharge times, becomes less negative with increased discharge time, and eventually crosses zero at about 10 hours. For the conventional double U-tube design (HDPE DBL) the zero crossing occurs at about 7 hours. For a high thermal conductivity shell pipe design, U-tubes may be either HDPE or Copper (Cu). Advantageously, these designs have zero crossing near discharge times of 1.0 hours. Zero crossings tend to occur at shorter discharge times as nominal BTR is lowered.

The prior art approach to analyzing discharge from a complex RC network is to separately consider exponential decay from each node. In the general case for multiple stages, the decay rate for a system is dependent on multiple time constants τᵢ, and is well represented as the sum of the decay for individual stages:

$$f ( t ) = {\sum }_{i} {a}_{i} ( 1 - exp ( - \frac{t}{{τ}_{i}} ) ) \qquad Equation 13$$

where aᵢ are the coefficients of each term
   τᵢ are the time constants of each term, equal to the product Rᵢ*Cᵢ
   t is time, and t=0 is the time when discharge is initiated

Function f(t) can be fully specified by determining each of the coefficients and time constants. Importantly, time constants r, are related to analogous resistances and capacitances as: τᵢ=RᵢCᵢ. One approach is to find these RC time constants by fitting discharge (also called decay or recovery) curves. Resistance and capacitance of each stage can also be found by reference to material parameters. The fundamental equations are given as:

$${R}_{i} = \frac{ln ( {r}_{i + 1} / {r}_{i} )}{2 πκ ( 2 * L )} ; {C}_{i} = ρ {C}_{P} π ( {r}_{i + 1}^{2} - {r}_{i}^{2} ) * ( 2 * L ) \qquad Equation 14$$

where L is the vertical length of the U-tubes

The convention adopted above for assigning R values is again applied, such that rᵢ₊₁=A*rᵢ, and A is a constant found as:

$$A = {( \frac{1.5 \sqrt{α t}}{{r}_{BORE}} )}^{1 / N} \qquad Equation 15$$

where N is the number of annular rings into which the space is divided

For SPICE analysis, N=30 has been found to be a good tradeoff on accuracy and complexity.

Discharge time constants are short when discharging small capacitances through small resistances. Experience with the decay problem indicates that the first few time constants can be ignored when decay times are sufficiently long.

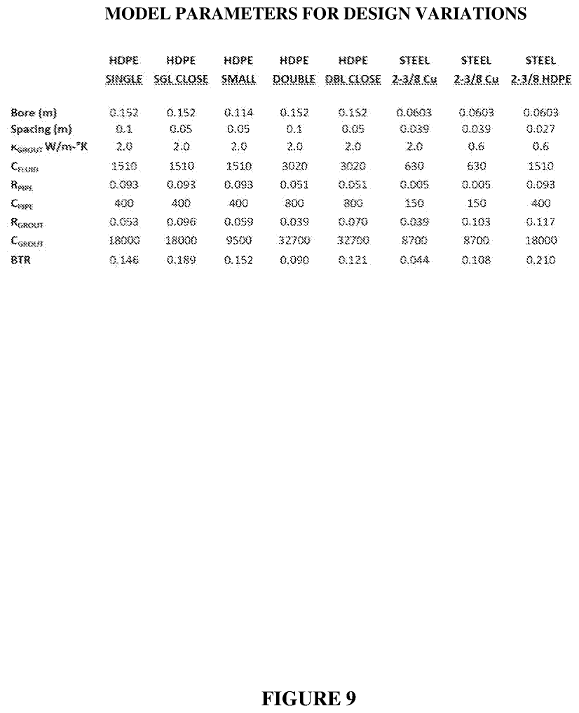

The RC time constants are independent of U-tube length, since the factor (2*L) cancels upon multiplication of R and C. Model parameters for resistances and capacitances are shown in FIG. 9 for eight design variations of interest. Included are conventional HDPE single and double U-tube designs with borehole diameter of 0.114 m (4.5″) or 0.152 m (6″) and spacing of 0.05 vs. 0.1 m. Other designs considered are based on an unconventional 2-⅜″ steel shell, populated with either copper or HDPE U-tubes. While other values tend to be fixed, ground resistances and capacitances must be calculated first with well-defined ground properties, and second at a specific time following a precise heat charging cycle. All resistances and capacitances are shown per unit borehole length.

For a given value of grout thermal conductivity κ_{GROUT}, resistance and capacitance values are shown along with calculated BTR.

It is well known in the art that for discharge of any system having multiple constants, just two or three of the time constants dominate at any point in time. Time constants associated with the pipe and grout quickly become unimportant since they are much smaller compared to ground time constants. Effects of shorter time constants can be excluded by choosing to measure and record temperatures at sufficiently long discharge times.

Q(t) is defined as:

$$Q ( t ) = T ( t ) / T ( 0 ) \qquad Equation 16$$

where T(0) is the temperature of circulating fluid at the time that heat input to the system is halted and discharge begins
   T(t) is the temperature of circulating fluid at some later time t

While the approach of fitting exponential time constants to the full curve of temperature vs. time is correct and useful for validating models, it is complex and not strictly necessary. The far simpler inventive approach is to a) measure and record temperatures; b) calculate Q(t), the ratio of circulating fluid temperature at time t to the temperature at initiation of discharge; and c) use simulations to directly determine ground properties based on Q(t) at two or more specific times.

From Q(t) at multiple times, both thermal conductivity κ_{GND} and volumetric heat capacity ρC_{P_GND} can be found to within some error band. The error band of extracted ground properties is smaller when evaluating discharging compared to charging. In particular, with evaluation of discharge error bands on extracted ground properties can be reduced by precisely selecting the specific discharge times.

Of course, error bands for extracted ground thermal conductivity and volumetric heat capacity are also subject to variation in the geometries and material properties of the borehole. Effectively, a theoretical model of the BTR must be applied to calculate the ground properties. The necessary assumption is that BTR is precisely known. To the extent that this assumption is valid, error bands on extracted ground properties are decreased.

### Simulations and Analysis of Results

The conclusion of many simulations is that the useful range of discharge ratio Q(t) is limited to 0.25<Q(t)<0.75. For example, with charge at 10° C. relative to the ground, measuring the decay down to 2.5-7.5° C. is most useful. For longer decays times and lower associated temperatures at time t, variation due to unknown ρC_{P_GND} values tends to increase.

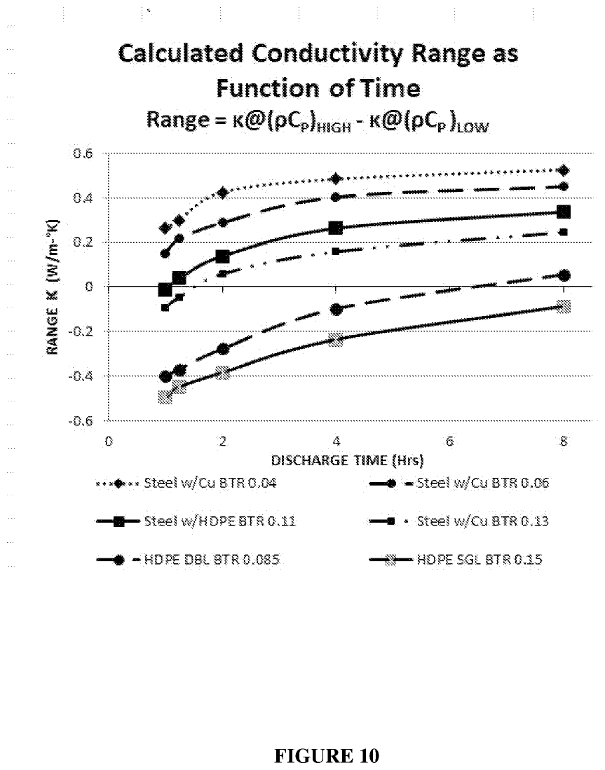

FIG. 10 is a plot of the Calculated Conductivity Range as a function of six different designs, showing the difference of calculated κ_{GND} for ρC_{P_GND}(High) and ρC_{P_GND}(Low), versus discharge time. Simulation results are shown for three different designs, each with two different values for BTR. Notably, one design has zero crossing at 1-2 hours; one design is projected to have zero crossing at less than 1 hour; and the other design is projected to have zero crossing at more than 6 hours. Of note is that for each of the three designs, zero crossing occurs at a later time when BTR is increased. This clearly indicates that time of zero crossing can be adjusted by design choices. A key objective is to narrow the range of extracted ground properties. In fact, this can be done by both carefully controlling all borehole design parameters and by choosing discharge times at which Q(t) is evaluated.

Of course, to best determine ground properties discharge times should be sufficiently long as to minimize any RC storage effects due to radii less than the borehole radius. For example, one hour discharge time might be taken as the lower limit for obtaining useful information.

Results from a matrix of simulations where thermal conductivity is varied while heat capacity is held constant are quite well-behaved. Indicative of this behavior, second-order fits completed for each value of ρC_{P} typically exhibit minimum correlation coefficient of 0.985.

After repeating such simulation analysis for a range of volumetric heat capacity values, second-order fit constants for Q(t) versus κ_{GND} and ρC_{P_GND} can be obtained. From this analysis, a first conclusion is reached that dependence of Q(t) on volumetric heat capacity can be separated from dependence on thermal conductivity. The extracted equation for Q(target) at a specifically targeted discharge time is summarized as:

$$Q ( target ) = f ( ρ {C}_{P} ) * exp ( A + B κ + C {κ}^{2} ) ; or \qquad Equation 17$$

$$Q ( target ) / f ( ρ {C}_{P} ) = exp ( A + B κ + C {κ}^{2} ) \qquad Equation 18$$

$$where f ( ρ {C}_{P} ) = a + b ρ {C}_{P} + c {ρ}^{2} {C}_{P}^{2} \qquad Equation 19$$

Taking the logarithm and rearranging:

$${κ}^{2} + ( B / C ) κ + ( A / C ) - ( 1 / C ) ln \{ \frac{Q ( target )}{f ( ρ {C}_{P} )} \} = 0 \qquad Equation 20$$

where constants a, b, c, A, B, C are obtained by fitting to simulation results, and again all constants are specific to the targeted discharge time

From this form, it is obvious that the quadratic formula can be applied to solve for volumetric thermal conductivity with any given Q(target) and for any practical value of ρC_{P}. A solution is obtained by selecting a specific value of ρC_{P}, then solving for κ. Assuming in succession a minimum value and a maximum value of ρC_{P} results in two discrete solutions that together define a range of possible thermal conductivity values (error bands). With careful choice of target time, such range of thermal conductivity values is acceptably small. Preferably, the target time is chosen such that variation of Q(t) with ρC_{P} is near minimum.

Since the matrix of simulations is made self-consistently, it is not surprising that the quadratic fits are typically good to better than 1.0% of the exact simulated values.

For example, specifically for the conventional HDPE single U-tube; κ_{GROUT}=2.7 W/m-° K; and 60 hour charge time at T_{AVERAGE}=13.75° C., coefficients are extracted as a function of time. In this instance, a second-order fit to f(ρCₚ) is made. Heat capacity is normalized to ρC_{P}=2.1×10⁶:

$$f ( ρ {C}_{P} ) = 1 + ( - \text{.15} + \text{.064} * ln ( t ) ) * ρ {C}_{P \_ norm} + ( \text{.031} - 0.16 ln ( t ) ) * {( ρ {C}_{P \_ norm} )}^{2} \qquad Equation 21$$

For the chosen example design and 0.63<ρC_{P_norm}<2.14, f(ρC_{P_norm}) varies from 0.847 to 0.925. For this design with discharge time t in units of hours:

$$A ( t ) = - \text{.007} - \text{.058} * ln ( t ) - \text{.067} * ln ( t ) \qquad Equation 22$$

$$B ( t ) = - 0.267 - 0.114 * ln ( t ) \qquad Equation 23$$

$$C ( t ) = 0.025 + 0.013 * ln ( t ) \qquad Equation 24$$

At 8.0 hour discharge time and Q(8 hr)=0.300; calculations indicate that 1.86<κ<1.94 across the full studied range of ρC_{P_GND} values. From FIG. 10, it is projected that a yet more accurate estimate of ground thermal conductivity might be made at discharge time of 10 hours. This approach using the quadratic formula is quite effective.

For any specific borehole design and combination of charge and discharge times, a matrix of simulations may be run to extract the appropriate constants and optionally a lookup table created to summarize the results. Information that can be gained on the local soil/rock properties potentially enables further narrowing of the thermal conductivity range. However, the inventive test-in-place system and method produces effective ground properties, which better predict the actual performance of the ground heat exchanger compared to prior art approaches.

For the same design at 1 hour discharge time, expected Q(1 hr) varies from 0.533-0.612. Turning this around, at Q(1 hr)=0.533, 1.94<κ<2.5; while at Q(1 hr)=0.612, 1.38<κ<1.86. This illustrates the dramatically narrowed range of estimated κ_{GND} values by selecting the optimum discharge time for evaluation.

Again, for best results all BTR values should be precisely known. The system and method is equally applicable to multiple U-tube designs to the extent that BTR is precisely known and reproducible. The conventional HDPE design suffers from variation mainly in pipe-to-pipe spacing and grout thermal conductivity.

Finally, to fit the standard form for exponential decay, the equation for Q(t) can be written as:

$$Q ( t ) = f ( ρ {C}_{P} ) * exp ( - t / RC ) = f ( ρ {C}_{P} ) * exp ( A + B κ + C {κ}^{2} ) \qquad Equation 25$$

$$Therefore , - \frac{t}{RC} = ( A + B κ + C {κ}^{2} ) \qquad Equation 26$$

Solving for RC:

$$RC = - t / ( A + B κ + C {κ}^{2} ) \qquad Equation 27$$

Once the range of thermal conductivity κ_{GND} is found, knowledge of volumetric heat capacity ρC_{P_GND} can also be narrowed by reference to Q(t) at other discharge times. For example, once determined from Q(8 hr) that 1.86<κ<1.94, if Q(1 hr)=0.57 then again from either calculation or lookup table ρC_{P_GND}˜2.1×10⁶. The range of ρC_{P_GND} cannot be easily specified. Fortunately, such estimate is adequate for final U-tube design calculations since ρC_{P_GND} is less important compared to κ_{GND}.

Extracted values for both effective ground thermal conductivity and volumetric heat capacity can be compared to other information. For example, disagreement of extracted values with known information on soil types may be indication that effective ground properties are influenced by stagnant or moving water pockets.

Simulation results are further illustrated in several following figures.

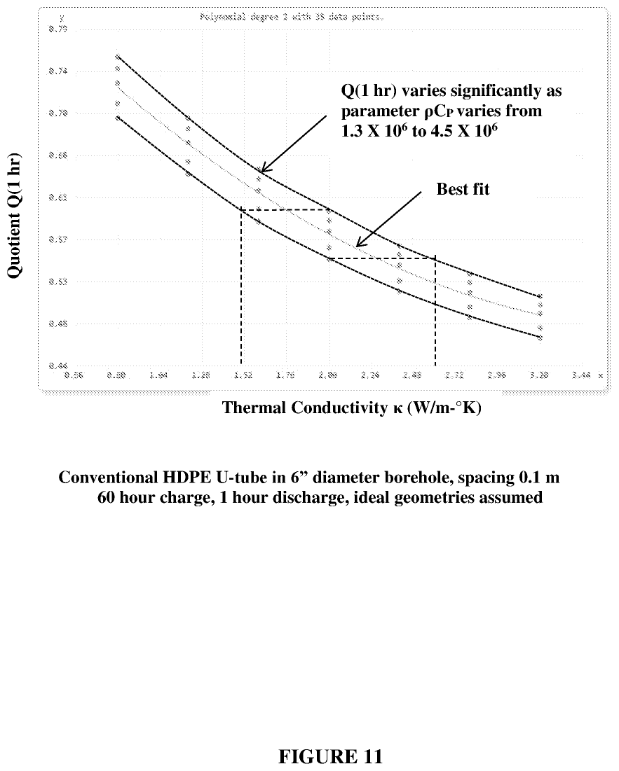

FIG. 11 displays simulation data for a conventional HDPE U-tube in a 6″ diameter borehole. ideal pipe spacing of 0.1 m (3.96″); and κ_{GROUT}=2.0 W/m-° K. The heat exchange system is charged for 60 hours with T_{AVERAGE}=13.75° C. Volumetric heat capacity is varied as a parameter from 1.32×10⁶ to 4.5×10⁶ J/m³-° K. Quotient Q(t) is shown at 1.0 hour discharge time as both thermal conductivity κ_{GND} and volumetric heat capacity ρC_{P_GND} are varied. With 35 total data points, variation of Q(t) with κ_{GND} and ρC_{P_GND} is clear. The dotted lines indicate that even though the simulation input is for κ_{GND}=2.0 W/m-° K exactly, from measurements of Q(t) at this decay time, the best fit determination is 1.5<κ_{GND}<2.65 due to unknown value of ρC_{P_GND}. Importantly, this determination is optimistic, because geometries are held constant at ideal values for these simulations.

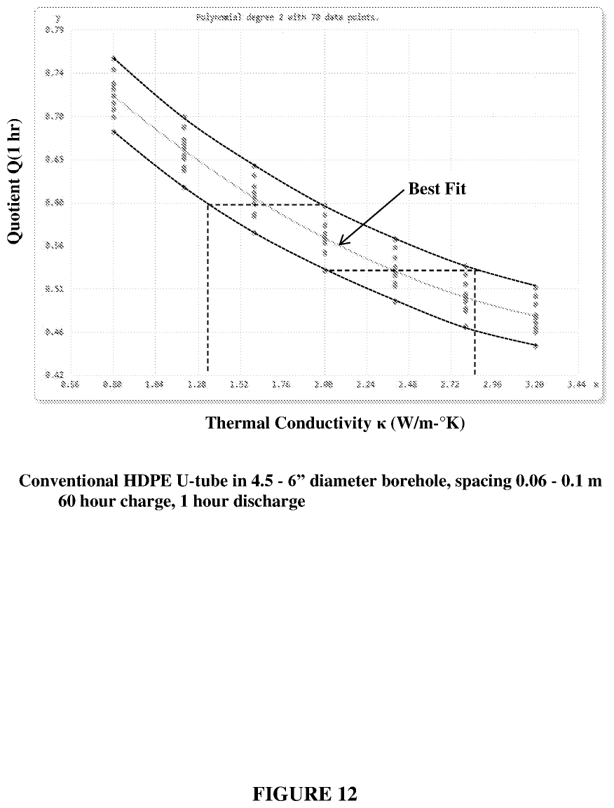

FIG. 12 expands on the example from FIG. 11 by further encompassing geometry variations. Again, data relates to the conventional HDPE U-tube, with heat exchange system charged for 60 hours; T_{AVERAGE}=13.75; and κ_{GROUT}=2.0 W/m-° K. Volumetric heat capacity is varied as a parameter from 1.32×10⁶ to 4.5×10⁶ J/m³-° K. Quotient Q(t) is again shown at 1.0 hour discharge time as both thermal conductivity κ_{GND} and volumetric heat capacity ρC_{P_GND} are varied. However, data from both the ideal and less than ideal geometries are included. To illustrate potential geometry effects, a 4.5″ vs. 6.0″ diameter borehole is included, along with pipe spacing of 0.06 m (2.54″) vs. near-ideal 0.1 m (3.96″). With 70 data points included, variation of Q(t) with κ_{GND} and ρC_{P_GND} is broadened. The dotted lines show that even though the exact simulation input is that κ_{GND}=2.0 W/m-° K, from measurements of Q(t) at this decay time the best fit determination is 1.05<κ_{GND}<2.3 due to unknown value of ρC_{P_GND}. Importantly, this analysis still assumes that R_{GROUT} is precisely known. The final range in extracted κ_{GND} must be yet larger, making the measurement of little value.

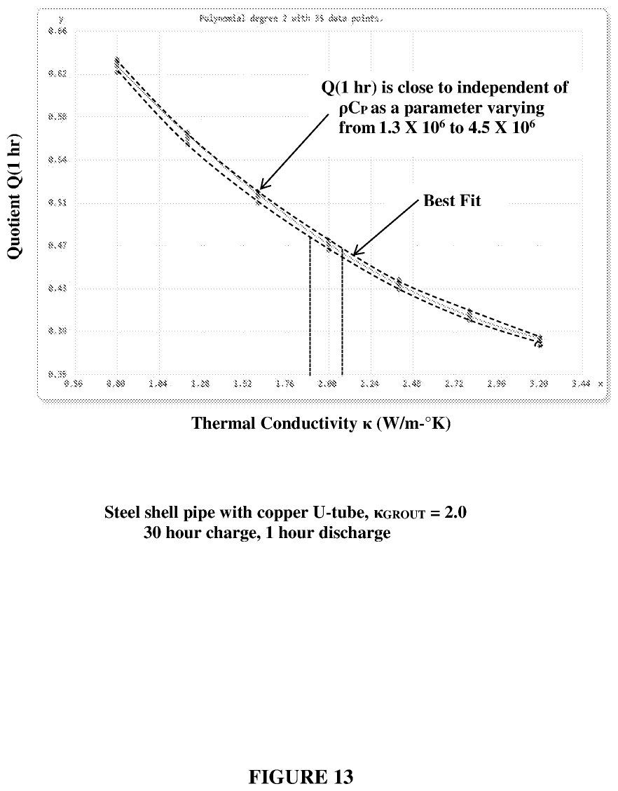

FIG. 13 displays simulation data for an unconventional 2-⅜″ diameter steel shell pipe with copper U-tubes. Thermal Conductivity κ is varied from 0.8 to 3.2 W/m-° K for unconventional design with 2-⅜″ diameter steel shell pipe with copper U-tubes. Volumetric heat capacity is varied as a parameter from 1.32×10⁶ to 4.5×10⁶ J/m³-° K. Pipe spacing of 0.039 m (1.5″) is heavily constrained by the inner diameter of the steel pipe and hardly subject to variation; The heat exchange system is charged for 30 hours with T_{AVERAGE}=13.75 and κ_{GROUT}=2.0 W/m-° K. Quotient Q(t) is shown at 1.0 hour discharge time as both thermal conductivity κ_{GND} and volumetric heat capacity ρC_{P_GND} are varied. Of the 35 data points shown, there is a small spread in values for different ρC_{P_GND} at each given value of κ_{GND}.

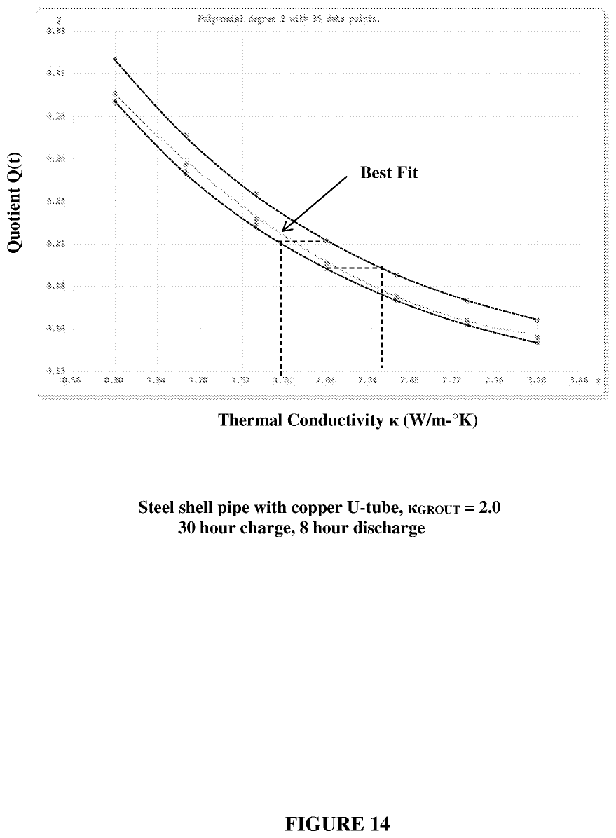

FIG. 14 is an illustration of the same system as in FIG. 13, charged for 30 hours and evaluated at Q(8 hr) or 8 hour discharge time. In sharp contrast to the evaluation at Q(1 hr), there is significant variation in extracted value of κ_{GND} as ρC_{P_GND} is varied. From this chart, extracted range is 1.75<κ<2.3. Referring to FIG. 10, there is a clear advantage in evaluating at 1 hour rather than 8 hours with the shell pipe design. Also of note is that the relevant values of Q(t) at 8 hours are about 0.19-0.21, which is outside the previously recommended range of 0.25<Q<0.75. Evaluating this system at 8 hour discharge time is certainly not recommended.

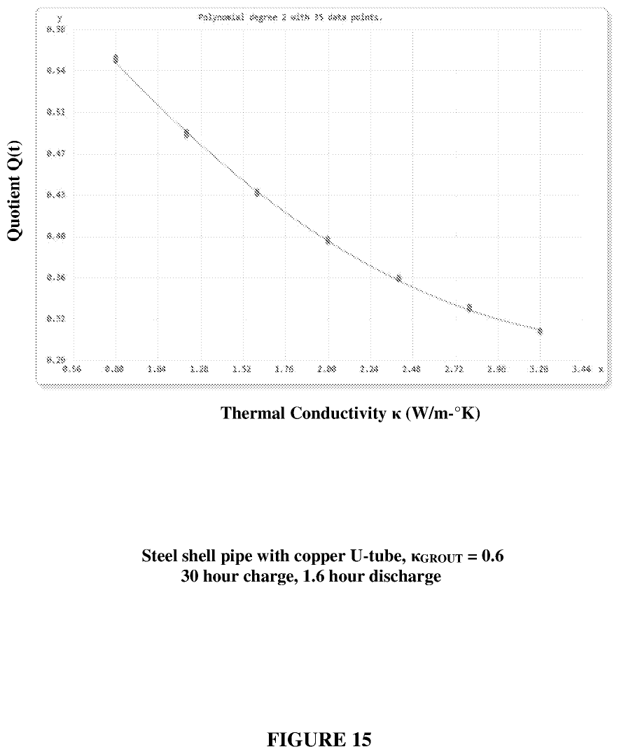

FIG. 15 is an illustration of simulation data for an unconventional 2-⅜″ diameter steel shell pipe with copper U-tubes. Pipe spacing of 0.039 m (1.5″) is again heavily constrained and hardly subject to variation. The heat exchange system is charged for 30 hours with T_{AVERAGE}=13.75 and κ_{GROUT}=0.6 W/m-° K. Quotient Q(t) is shown at 1.6 hour discharge time as both thermal conductivity κ_{GND} and volumetric heat capacity ρC_{P_GND} are varied. Although there are 35 data points, it is difficult to distinguish any variation at a given value of κ_{GND}. Q(t) is almost independent of ρC_{P_GND} at this specific discharge time. For this specific design, the time of zero crossing is increased above 1.0 hour by applying grout having lower thermal conductivity.

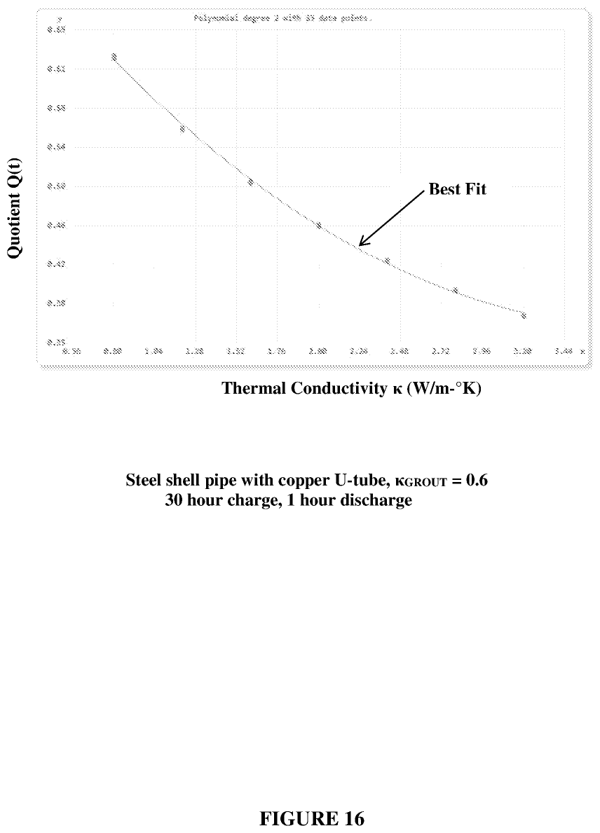

FIG. 16 is an illustration of simulation data for an unconventional 2-⅜″ diameter steel shell with HDPE U-tubes. Pipe spacing of 0.027 m (1.1″) is again heavily constrained and hardly subject to variation. The heat exchange system is charged for 30 Hours with T_{AVERAGE}=13.75 and κ_{GROUT}=0.6 W/m-° K. Quotient Q(t) is shown at 1.0 hour discharge time as both thermal conductivity κ_{GND} and volumetric heat capacity ρC_{P_GND} are varied. Although there are 35 data points, it is difficult to distinguish any variation at a given value of κ_{GND}. Again, Q(t) is almost independent of ρC_{P_GND} at this specific discharge time. For this specific design, both grout having lower thermal conductivity and pipes having lower thermal conductivity have been applied. This combination might result in increased ground loop length compared to other designs, but is ideal for separation of variables leading to accurate determination of ground thermal properties.

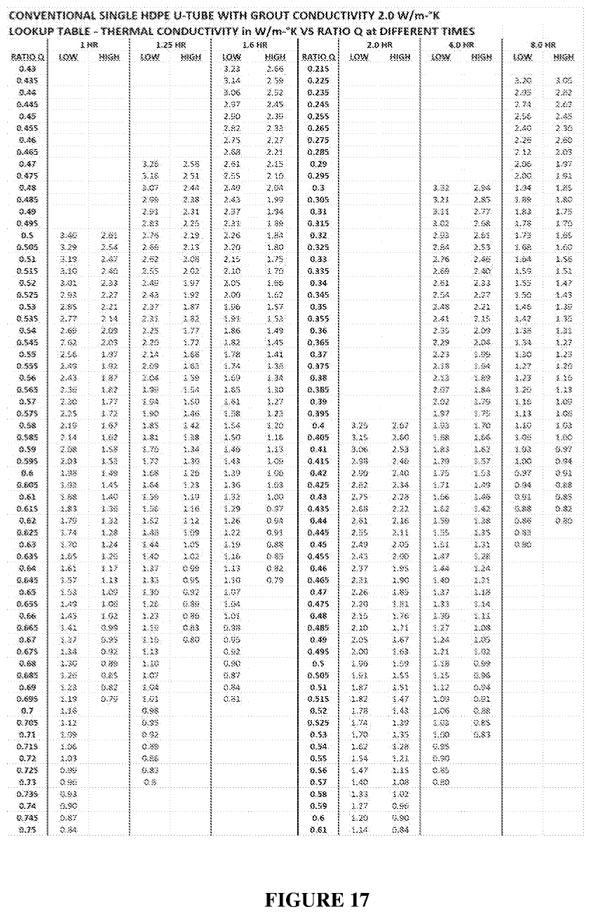

FIG. 17 is a lookup table for the conventional HDPE U-tube in a 6″ diameter borehole with ideal pipe spacing of 0.1 m (3.96″). The heat exchange system is charged for 60 hours with T_{AVERAGE}=13.75 and κ_{GROUT}=2.0 W/m-° K. It can be seen that for all shown discharge times of 1.0-8.0 hours, κ_{GND} is anti-correlated with ρC_{P_GND}. This is expected, since the projected zero crossing in FIG. 10 occurs at about 10 hours.

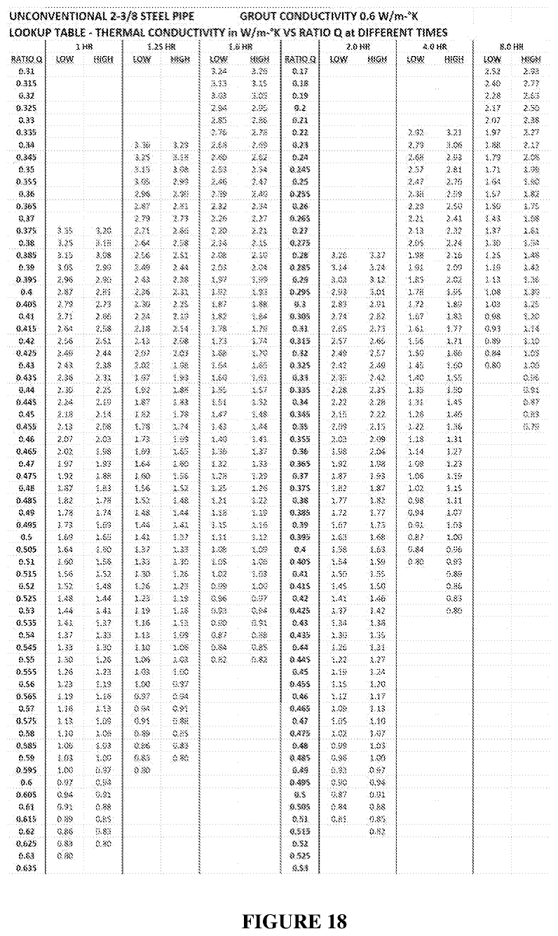

FIG. 18 is a lookup table for an unconventional 2-⅜″ diameter steel shell pipe with copper U-tubes. The heat exchange system is charged for 30 hours with T_{AVERAGE}=13.75 and κ_{GROUT}=0.6 W/m-° K. It can be seen that κ_{GND} is anti-correlated with ρC_{P_GND} for discharge times 1.0 and 1.25 hour, crosses zero at about 1.6 hours, and is correlated with ρC_{P_GND} for longer times.

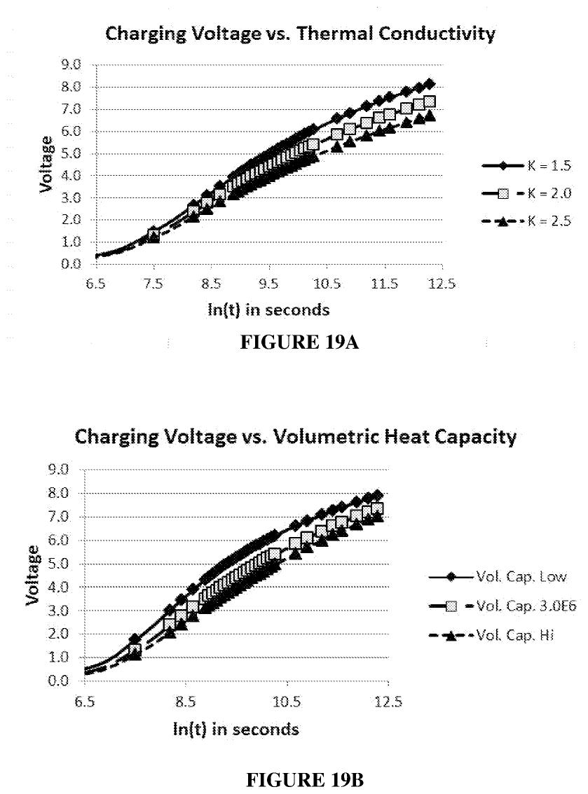

FIG. 19A and FIG. 19B are plots of simulated charging voltage for a conventional ground loop with HDPE U-tube. Both plots show the rise in voltage vs. logarithm of time, with charging beginning at time t=0. FIG. 19A includes thermal conductivity κ_{GND} as a parameter, while FIG. 19B includes volumetric heat capacity ρC_{P_GND} as a parameter. It can be seen that increase of charging voltage with time is sensitive to both κ_{GND} and ρC_{P_GND}, and in fact is almost equally sensitive to the two parameters. This highlights that it is difficult to separate variables based on charging data, as is the case with prior art testing.

### Summary: System, Method, and Apparatus for Determining Ground Thermal Conductivity and Volumetric Specific Heat

Consider a system comprised of a U-tube installed specifically to enable measurements during the first few days of heating or cooling, with pump, flow-through heating apparatus and valves as illustrated in FIG. 6. Fluid circulating through the U-tube introduces heat energy in exactly the same way as a normal, final ground heat exchange installation. By holding the circulating fluid at a constant temperature for a significant charging time period, then removing the heat source while measuring and recording the change in fluid temperatures EWT and LWT during discharge, a good estimate of the effective thermal conductivity of the surrounding ground can be found, followed by estimate of effective volumetric heat capacity.

For clarity, the method for determining thermal conductivity within certain bounds is summarized as:
1) Obtain estimates of local constant ground temperature at depth of 5 meters or more.
2) Position U-tube 102 of known length vertically into the ground and force into intimate thermal contact with the surrounding ground by.
3) Fill volume between U-tube and surroundings with thermally-conductive material.
4) Make fluidic connections and turn on pump 108 to circulate fluid at the constant mass flow rate required to minimize convective thermal resistance.
5) Circulate fluid without any heat input for about 10 minutes while measuring EWT and LWT, or until the temperatures are stable at close to estimated local constant ground temperature.
6) Close valve 114 and open valve 120 to direct fluid flow through flow-through heating apparatus 106 set at constant power and to a specific target temperature above the constant ground temperature, while maintaining constant fluid mass flow rate. Apply the output of flow through heating apparatus 106 to the input side (down-going) of U-tube 102.
7) Maintain flow rate at target temperature and “charge” for 30 hours, for example, while measuring and recording EWT and LWT (use longer charge time if needed for particular borehole design).
8) Open valve 114 and close valve 120 to bypass the flow-through heating apparatus 106. Continue constant fluid mass flow rate for targeted “discharge” time while noting EWT and LWT. Measure and record the fluid temperatures either continuously or at specific intervals.
9) Complete a simulation matrix for the specific design with variables κ_{GND} and ρC_{P_GND}; then develop a quadratic fit for Q(t), the ratio of temperature after elapsed discharge time to the temperature at the time that heat input is halted. A minimum of 5 values should be used for each of thermal conductivity and volumetric heat capacity. Calculate such matrix at multiple discharge time intervals of interest.
10) Refer to table of calculated thermal conductivity vs. volumetric heat capacity at low and high ρC_{P_GND} values of 1.3×10⁶ J/m³-° K and 4.5×10⁶ J/m³-° K for a specific discharge time interval. Thermal conductivity is estimated as being the mean of these calculated values.
11) Use the thermal conductivity range determined from relatively short time interval and refer to matrix at other time intervals to estimate the volumetric heat capacity.

Volumetric heat capacity ρC_{P_GND} typically ranges from 2.1×10⁶ to 4.5×10⁶, average 3.0×10⁶ J/m³-° K. Of this, soil density p typically varies from 1500-3000 kg/m³ (with some moisture present); while specific heat capacity C_{P} ranges from 700 and 2400 J/kg-K. Because density and specific heat are inversely correlated for soils, and also due to effect of square root function, the effect of variation in volumetric heat capacity ρC_{P_GND} on diffusivity α is only about +/−20% for the full range of soil types. This is fortunate, since it is difficult to accurately determine volumetric heat capacity from relatively short-term experiments using a probe. Note that variation in soil porosity and moisture content result in significant variation in volumetric heat capacity even for a given soil composition.

Calculating thermal diffusivity α=κ_{GND}/ρC_{P_GND}, while using the full range on κ_{GND} from about 0.8-3.2 W/m-K, results in diffusivity range from 0.1×10⁻⁶ to 4.0×10⁻⁶, average 1.5×10⁻⁶ m²/sec. Density p and specific heat capacity C_{P} are inversely related with correlation coefficient of about 0.85 for clay, sand, silt and gravel. Because this correlation drives the product ρC_{P} towards a central value, for the large majority of cases α is between 0.4×10⁻⁶ and 2×10⁻⁶ m²/sec. As a good starting point, assume that κ_{GND}=2.0 and volumetric heat capacity ρC_{P_GND}=2.5×10⁶; leading to α=0.8×10⁻⁶ for most sand, clay, or gravel soils.

The borehole thermal resistance (BTR) or equivalent must be known with high accuracy. This means that all installation parameters must be well controlled. As previously highlighted, in the conventional case the heat convection component can be neglected assuming only that fluid mass flow rate is sufficiently high. For single HDPE U-tube, 6 inch diameter borehole and grout κ=2.0, BTR˜0.16 m-° K/W. For same size and grout, double HDPE U-tube has BTR˜0.09 m-° K/W.

### Direct Push

In one or more preferred embodiments, the invention relies on application of direct push technology. Direct push is a method of inserting a pipe predominantly vertically into the ground, although angles up to 45 degrees are possible. Similar to a hammer impact nail-driver or screw-driver, friction is largely overcome by repeatedly applying impact force to the top end of the pipe. An impact hammer can be used to apply force, with assist from a) pneumatics; b) hydraulics; or c) the weight of the tool itself. A drive shoe optionally is temporarily positioned over the top end of the pipe to better distribute the force and to minimize damage to the pipe end.

Pipe direct push technology has been developed and commonly used for obtaining soil samples, and typically involves some combination of hydraulically-applied force and impact methods. A conically-shaped head is often attached to a long shank portion, with the point of the head leading into the ground. The total length of the shank can be incrementally increased by adding sections as penetration progresses.

Friction for the pipe head is considered separately from friction along the shank. Direct push technology relies on first minimizing the force required to incrementally advance the pipe head into the ground, and second on minimizing friction along the shank of the pipe. When the shank diameter is less than the head diameter, a first approximation is that shank friction is zero in soils that are subject to compression.

Vibration of the soil adjacent to the pipe head and shank can act to reduce friction, enabling further penetration. Vibrations can be initiated along the pipe by periodic application of impact force. Compressional waves, launched in response to applied impact force, travel up and down the pipe. With some care, the compressional waves reinforce constructively at the natural resonance frequency. In such case, conditions are set for adjacent soil to remain in constant motion, with greatly reduced contact with the shank leading to greatly reduced friction.

Direct push is most applicable for use in unconsolidated soils. When encountering smaller rocks, progress may be maintained as the conical pipe head either breaks up the rock or pushes the rock out of the path.

To enable penetration, the soil immediately beneath the head must be rearranged, compressed or pushed to the side. Just as with a nail, friction at the head can be minimized by forming a pilot hole in advance. In soil types subject to caving, such as sand or gravel, removal of material from the path taken by the pipe can act to minimize cave-in or collapse as the pipe progresses. This in turn reduces friction along the shank of the pipe.

Overall, there is potential to reduce costs and improve performance by applying the direct push technology to insert pipes with little or even no drilling.

### Engineering Overall U-Tube Length

The total required U-tube length can be simulated for a specific project. If feasible, it is desirable to install a single U-tube having the required length. However, almost always this total length must be divided into two or more U-tubes. Most typically, conventional U-tubes extend 200-400 feet below the ground surface. For example, with a requirement to exchange heat from a 3 ton AC system, the total required U-tube length might be 1,200 feet, which might be divided into 4 U-tubes each having 300 foot length.

Specifically with direct push, exceeding single U-tube length of about 100 feet might be difficult in some ground formations. In such case, the total length may be divided into 4-20 individual U-tubes. Overall, installed costs are dominated by material and labor costs, which tend to be proportional to overall length. Two inefficiencies result from having multiple, separate U-tubes. First, the manifold enabling series-parallel connections of various U-tubes becomes more complex as the number of U-tubes increases, perhaps leading to increased costs. Second, each U-tube is less effective at exchanging heat above the constant temperature zone, which begins at 10-15 feet depth. In the extreme, these first few feet of U-tube might be considered as having zero contribution to heat exchange. If a single, 1,200 foot long U-tube is applied, to compensate for the ineffective portion the total length must be increased to 1,220 feet. The resulting inefficiency amounts to 1.7 percent. On the other hand, if 12 U-tubes, each 100 foot long are applied to meet the same initial 1,200 foot requirement, to compensate for the ineffective portions the total length must be increased to 1,440 feet. The resulting inefficiency amounts to 20 percent.

One important approach is to perform any tests in such a way that expenditures are not wasted, but can be directly applied to the project. With this in mind, it is helpful to make the project more modular. Instead of 4 deep boreholes, a design for 8-9 boreholes both means that each hole is less deep, but also that the cost of a first borehole is reduced. Furthermore, there is no requirement that every borehole be of the same length. A first borehole might be purposely shortened to minimize financial risk, with some tradeoff on the accuracy in determining “effective” ground properties.

A single borehole can be formed, populated with ground loop piping, grouted or otherwise filled, and tested to extract needed information on ground thermal properties. If economic analysis based on ground parameters proves disappointing, the single installation might simply be abandoned. Proactively armed with data from other sites nearby, the more likely outcome is that ground parameters prove favorable, and the single U-tube becomes the first of the several to be installed. Importantly, test data obtained from a first U-tube enables design optimization of overall U-tube length, thereby leading to cost reduction while simultaneously managing overall financial risk.

### Validation and Calibration

With any specific design for the heat exchange system, including details of U-tube, grout, shell pipe or borehole, some initial calibration may be required. RC network input values used in simulations must be adjusted to match real-world studies. The only observable data leading directly to calculation of discharge ratio Q(t) are temperatures EWT and LWT over time. Calibration adjustments must be made to match this data.

If both the assumed RC network input values and the applied model are correct, then the output results must inevitably deliver the correct effective ground properties. Alternatively, incorrect assumed values for geometries and the material thermal properties may lead to error in extracted ground properties.

All resistance components of BTR are well studied and validated. Of these, grout resistance is important and estimates of BTR strongly depend on accuracy of published values for density and specific heat capacity. Grout resistance also depends on U-tube spacing, which can vary considerably in conventional designs. As the input variable for the simulation matrices, ground resistance values are not subject to challenge. Overall, all resistance values generally may be assumed to be accurate to the extent that grout properties and U-tube spacing are well known. Therefore, calibration efforts should prioritize appropriate adjustment of capacitance values.

According to the inventive system and method, effective thermal ground properties are extracted based on discharge temperature (voltage) vs. time. One immediate way to validate these ground properties is to compare the actual temperature vs. time curve during charging with the projected curve based on the simulation model. A good match indicates that both the simulation model and the input parameters are likely valid. Alternatively, the response to discrepancies should be to make adjustments in certain capacitance input values.

As with resistance, capacitances associated with BTR and ground should be separately considered. Capacitance of both circulating fluid and U-tube pipe tend to have smaller values compared to grout capacitance. Therefore, re-evaluation of grout capacitance might be prioritized as a first response towards adjusting to calibration data. However, grout capacitance is based on easily-calculated grout volume and well-established material constants.

Conservatively, grout capacitance is unlikely to vary by as much as +/−30%. Grout capacitance in turn depends linearly on assumed volumetric heat capacity, which is the product of density and specific heat. Both values vary with moisture, but wet clay is only about 5% more dense compared to dry clay. Summarizing data on soil from Abu-Hamdeh, about +/−30% variation in volumetric heat capacity with moisture might be expected.

The potential effect of variation in grout capacitance on extracted ground properties is dramatically reduced for an unconventional design based on a steel shell pipe, with an ˜8× reduction in grout volume compared to a conventional design.

More likely, ground capacitances must be adjusted. Due to the method employed in calculating ground capacitance for each node, any required adjustment can be made by simply multiplying C₁, the capacitance of the first annular ring, by a constant. All other ground capacitance values are then obtained as a multiplicative product of C₁.

For the conventional design based on HDPE pipe, varying C_{GROUT} by 30% results in less than 4% change in simulated temperature at 8 hours discharge time. Similarly, multiplying or dividing all C_{GROUND} elements by factor 4.0 results in less than 4% change in simulated temperature at 8 hours discharge time. For this design, adjustment of C_{GROUT} should be prioritized, followed by multiplicative adjustment of all C_{GROUND} values.

For the unconventional design based on steel shell pipe, increasing C_{GROUT} by 30% while doubling all C_{GROUND} elements has modest impact. With these changes, the zero crossing increases from 1.0 hour to 1.6 hours. At 1.0 hour discharge time, calculated κ at maximum ρC_{P} is on average just 4% lower compared to κ at minimum ρC_{P}. Therefore, this design appears to be relatively insensitive to erroneous assumptions on capacitance values.

Unsurprisingly, variation of grout capacitance has more impact on shorter discharge times, while ground capacitance has more impact on longer discharge times. Simulations at short discharge times depend more strongly on assumed grout capacitance. As a general rule, grout capacitance input value should be adjusted to match calibration data at 1.0 hour charge time, while ground capacitance input value should be adjusted to match calibration data at 8.0 hour charge time.

The invention claimed is:

1: A heat exchange system for testing to determine effective ground thermal properties, comprising
an elongate shell pipe having thermal conductivity greater than about 5 W/m-° K; wherein said shell pipe is closed at the bottom end, is positioned approximately vertically in surrounding ground and is in intimate thermal contact with said surrounding ground;
a U-tube assembly positioned within said elongate shell pipe, comprising a down pipe, an up pipe, and a U-turn element wherein fluid may be serially conducted from inlet of said down pipe through said U-turn element to outlet of said up pipe with minimal flow restriction;
a thermally-conductive material filling the volume between inner radius of said elongate shell pipe and outer radii of said down pipe and said up pipe;
a flow-through heating apparatus having an inlet and an outlet and capable of exchanging a calibrated thermal power with a moving fluid;
a serial fluidic connection from outlet of said flow-through heating apparatus to a first series valve and thence in succession to a pump, to said down pipe, said U-turn element, said up pipe, and inlet of said flow-through heating apparatus;
an electrical power source having control means for exchanging calibrated thermal power into said moving fluid;
control means for actuating said first serial valve, de-actuating a second parallel valve, and powering said pump to route fluid flow through said flow-through heating apparatus at the start of a charging cycle and for de-actuating said first serial valve, actuating said second parallel valve to route fluid flow to bypass said flow-through heating apparatus at the start of discharging cycle;
means for measuring and recording test data on fluid flow rate, calibrated thermal power exchanged into said flow-through heating apparatus, and temperature of both fluid entering said down pipe and fluid leaving said up pipe at multiple times during both charging cycle and discharging cycle;
means for calculating range of effective ground thermal conductivity based on assumption in turn of upper and lower bounds for ground volumetric heat capacity and data from one or more tests wherein said data is obtained both at start of discharge and at a first later discharge time when ratio of temperature at said first later discharge time to temperature at start of discharge is known to be both dependent on ground thermal conductivity and nearly independent of volumetric heat capacity.

2: The system of claim 1, further comprising switching means and switching control means for operating first serial valve and second parallel valve to alternately route fluid flow on demand between path including said flow-through heating apparatus and path not including said flow-through heating apparatus.

3: The system of claim 1, wherein knowledge of dependency on ground thermal conductivity and ground volumetric heat capacity with discharge time is supported by analysis of data obtained from a multiplicity of simulations based on
an electrical model representing said shell pipe, said U-tube assembly, said thermally-conductive filler material, and said surrounding ground as a resistor-capacitor network with voltage at each node representing temperature;
data obtained from said multiplicity of simulations applying said electrical model of a charging cycle followed by a discharging cycle, wherein
during charging cycle one input to said simulation comprises connection to an electrical power source held constant for a specified time to represent constant thermal power input;
during discharging one input to said simulation comprises disconnection of said electrical power source to represent isolation of said U-tube assembly and said surrounding ground for a specified time to represent zero additional thermal power input;
simulated values are obtained at multiple discharge times for average temperature of circulating fluid with a range of input values of ground thermal conductivity and ground volumetric heat capacity at each time;
data summarizing each discharge time is optionally arranged in the form of a quadratic equation with thermal conductivity as the unknown value;
quadratic formula is optionally applied to solve for effective ground thermal conductivity based on ratio of temperature at a later discharge time to temperature at start of discharge time at and each of lower and upper bounds for effective ground volumetric heat capacity resulting in a range of effective ground thermal conductivity.

4: The system of claim 1, wherein effective ground volumetric heat capacity is calculated based on range of effective ground thermal conductivity and data from a second later discharge time when ratio of said data from said second later discharge time to initial discharge temperature is somewhat dependent on ground thermal conductivity and strongly dependent on effective ground volumetric heat capacity.

5: The system of claim 1, further comprising means for additionally determining effective ground thermal conductivity from the increase in temperature with time during charging cycle by fitting with exponential constants for at least three time periods.

6: The system of claim 1, further comprising
optimum times determined for calculation of effective ground thermal conductivity and effective ground volumetric heat capacity;
pre-calculated tables referred to based on simulation of temperature versus time to establish minimum and maximum values of effective ground thermal conductivity;
project feasibility decided, with possible outcomes of
a) the project may be judged as not meeting minimum requirements and abandoned;
b) the project may be continued with the first element becoming part of a vertical ground loop system.

7: An apparatus applied to determine effective ground thermal conductivity and effective volumetric heat capacity; wherein said apparatus comprises a shell pipe positioned vertically into the ground; a U-tube assembly inserted into the shell pipe and configured to conduct fluid from an input side to a return side, said U-tube assembly comprising a down pipe, a U-turn element and an up pipe; thermally-conductive filler material placed within the volume between inner radius of said shell pipe and outer radii of said down pipe and up pipes; a fluid pumping device; a flow-through heating device; two or more temperature sensors installed to detect at least the input side entering water temperature and return side leaving water temperature; devices for measuring and recording temperature and flow rate; and first series valve and second parallel valve operable to route heated fluid from said flow-through heating apparatus to said U-tube assembly during a charging cycle and to isolate said U-tube assembly from said flow-through heating apparatus during a discharging cycle; wherein a range of effective ground thermal conductivity is calculated based on assumption in turn of upper and lower bounds for ground volumetric heat capacity and data from one or more tests wherein said data is obtained both at start of discharge and at a first later discharge time when ratio of temperature at said first later discharge time to temperature at start of discharge is known to be both dependent on ground thermal conductivity and nearly independent of volumetric heat capacity.

8: The apparatus of claim 7, wherein effective ground volumetric heat capacity is calculated based on range of effective ground thermal conductivity and data from a second later discharge time when ratio of said data from said second later discharge time to initial discharge temperature is somewhat dependent on ground thermal conductivity and strongly dependent on effective ground volumetric heat capacity.

9: The apparatus of claim 7, further comprising a computer capable of performing a process and a computer readable program code that comprises the steps of
loading a model of the heat exchange system as a resistor-capacitor network with voltage at each node representing temperature;
simulating discharge temperature at multiple discharge times and each time with a range of input values of thermal conductivity and volumetric heat capacity;
summarizing data for each discharge time in quadratic equation form;
solving for effective ground thermal conductivity at a time when discharge temperature is dependent on effective ground thermal conductivity and nearly independent of effective volumetric heat capacity;
inputting solution on effective ground thermal conductivity and solving for effective ground volumetric heat capacity at a time when discharge temperature is significantly dependent on volumetric heat capacity.

10: A method for installing a ground-based heat exchange system and testing to determine effective ground properties, comprising
directly pushing a shell pipe portion of a first element of a ground loop system into the ground;
connecting first element of said shell pipe portion to second element of shell pipe portion and further directly pushing into the ground;
repeating connection and direct push for subsequent elements until desired total insertion length has been reached;
positioning a U-tube assembly, comprising a down pipe, an up pipe, and a U-turn element to conduct fluid from down pipe to up pipe with minimal flow restriction, into said shell pipe;
filling remaining shell pipe interior volume with material to thermally connect inner radius of said shell pipe to outer radii of down and up pipes;
forcing circulation of heated fluid through down pipe by connecting to outlet of a pump and a flow-through heating apparatus having calibrated thermal energy transfer rate;
activating flow-through heating apparatus and operating for a timed charging cycle;
de-activating flow-through heating apparatus to initiate discharging cycle;
measuring and recording entering water temperature and leaving water temperature at multiple charging and discharging times;
modeling said U-tube assembly, said material thermally connecting inner radius of said shell pipe to outer radii of down and up pipes, and said surrounding ground as a resistor-capacitor network with voltage representing temperatures;
simulating discharge temperature at multiple discharge times and each time with a range of input values of ground thermal conductivity and ground volumetric heat capacity;
summarizing data for each discharge time in quadratic equation form;
solving for range of effective ground thermal conductivity at a time when first discharge temperature is nearly independent of volumetric heat capacity and assuming in turn lower and upper bounds for ground volumetric heat capacity;
inserting solution on thermal conductivity as an input and solving for effective ground volumetric heat capacity at a later discharge time when ratio of temperature at second later discharge time to temperature at start of discharge is known to be somewhat dependent on ground thermal conductivity and nearly independent of volumetric heat capacity;
discharge temperature is significantly dependent on volumetric heat capacity.

11: The method of claim 10, wherein said shell pipe is sufficiently rigid to allow for direct insertion.

12: The method of claim 10, wherein said shell pipe has thermal conductivity greater than 5 W/m-° K.

13: The method of claim 10, wherein said shell pipe has diameter less than about 110 mm and preferably about 60 mm.

14: The method of claim 10, comprising step of activating said pump and operating for an initial time period prior to activating flow-through heating apparatus.

15: The method of claim 10, wherein said down pipe and said up pipe of said U-tube assembly are formed of copper.

16: A method for installing a ground-based heat exchange system and testing to determine effective ground properties, comprising
drilling a pilot hole in the ground having diameter smaller than outer diameter of a shell pipe to be inserted;
directly pushing a shell pipe portion of a first element of a ground loop system into said pilot hole in the ground;
connecting first element of said shell pipe portion to second element of shell pipe portion and further directly pushing into the ground;
repeating connection and direct push for subsequent elements until desired total insertion length has been reached;
positioning a U-tube assembly, comprising a down pipe, an up pipe, and a U-turn element to conduct fluid from down pipe to up pipe with minimal flow restriction, into said shell pipe;
filling remaining shell pipe interior volume with conductive material to thermally connect inner radius of said shell pipe to outer radii of down and up pipes;
forcing circulation of heated fluid through down pipe by connecting to outlet of a pump and a flow-through heating apparatus having calibrated thermal energy transfer rate;
activating flow-through heating apparatus and operating for a defined charging time;
de-activating flow-through heating apparatus to initiate discharge;
measuring and recording entering water temperature and leaving water temperature at several different discharge times;
modeling said U-tube assembly, said material thermally connecting inner radius of said shell pipe to outer radii of down and up pipes, and said surrounding ground as a resistor-capacitor network with voltage representing temperatures;
simulating discharge temperature at multiple discharge times and each time with a range of input values of thermal conductivity and volumetric heat capacity;
summarizing data for each discharge time in quadratic equation form;
solving for effective ground thermal conductivity at a time when discharge temperature is nearly independent of volumetric heat capacity;
inserting solution on thermal conductivity as an input and solving for effective ground volumetric heat capacity at a later discharge time when ratio of temperature at second later discharge time to temperature at start of discharge is known to be somewhat dependent on ground thermal conductivity and nearly independent of volumetric heat capacity.

17: The method of claim 16, wherein said shell pipe is sufficiently rigid to allow for direct insertion.

18: The method of claim 16, wherein said shell pipe has thermal conductivity greater than 5 W/m-° K.

19: The method of claim 16, wherein said shell pipe has diameter less than about 110 mm and preferably about 60 mm.

20: The method of claim 16, comprising step of activating said pump and operating for an initial time period prior to activating flow-through heating apparatus.

21: The method of claim 16, wherein said down pipe and said up pipe of said U-tube assembly are formed of copper.

22: A method for installing a ground-based heat exchange system and testing to determine effective ground properties, comprising
drilling a borehole in the ground having diameter larger than outer diameter of a shell pipe to be inserted;
inserting a shell pipe portion of a first element of a ground loop system into said borehole in the ground;
connecting first element of said shell pipe portion to second element of shell pipe portion and further directly pushing into the ground;
repeating connection and direct push for subsequent elements until desired total insertion length has been reached;
filling remaining volume between shell pipe outer diameter and borehole with thermally-conductive material to thermally connect shell pipe to surrounding ground;
positioning a U-tube assembly, comprising a down pipe, an up pipe, and a U-turn element to conduct fluid from down pipe to up pipe with minimal flow restriction, into said shell pipe;
filling remaining shell pipe interior volume with conductive material to thermally connect the inner radius of said shell pipe to outer radii of said down and said up pipe;
forcing circulation of heated fluid through down pipe by connecting to outlet of a pump and a flow-through heating apparatus having calibrated thermal energy transfer rate;
activating flow-through heating apparatus and operating for a timed charging cycle;
de-activating flow-through heating apparatus to initiate discharging cycle;
measuring and recording entering water temperature and leaving water temperature at several different discharge times;
modeling said U-tube assembly, said material thermally connecting inner radius of said shell pipe to outer radii of down and up pipes, and said surrounding ground as a resistor-capacitor network with voltage representing temperatures;
simulating discharge temperature at multiple discharge times and each time with a range of input values of thermal conductivity and volumetric heat capacity;
summarizing data for each discharge time in quadratic equation form;
solving for effective ground thermal conductivity at a time when discharge temperature is nearly independent of volumetric heat capacity;
inserting solution on thermal conductivity as an input and solving for effective ground volumetric heat capacity at a time when ratio of temperature at second later discharge time to temperature at start of discharge is known to be somewhat dependent on ground thermal conductivity and nearly independent of volumetric heat capacity.
